(19) United States
(12) Patent Application Publication
(10) Pub. No.: US 2008/0178025 A1
(43) Pub. Date: Jul. 24, 2008

(54) System and method for data manipulation

(76) Inventors: Leroy C. Hand, Vienna, VA (US); Arnold A. Anderson, Vienna, VA (US); Amy D. Anderson, Raleigh, NC (US)

Correspondence Address: DLA PIPER US LLP, P. O. BOX 9271, RESTON, VA, 20195, US

(21) Appl. No.: 11/510,642

(22) Filed: Aug. 28, 2006

Related U.S. Application Data
(63) Continuation of application No. PCT/US05/06008, filed on Feb. 25, 2005.
(60) Provisional application No. 60/548,110, filed on Feb. 27, 2004.

(51) Int. Cl. G06F 12/16; G06F 11/00; G06F 1/32

(52) U.S. Cl. 713/323; 714/48; 711/162; 714/E11.001; 711/E12.103

(57) ABSTRACT

An arrangement is provided for a data manipulation device disposed in a low profile form factor housing. A data manipulation device includes a memory configured to provide data storage and a backup storage configure to provide backup space when the memory is being backed up.

### FIELD OF INVENTION

This application is a continuation of International Application Number PCT/US2005/006008, filed Feb. 25, 2005, which claimed priority from U.S. Provisional Application No. 60/548,110, filed Feb. 27, 2004, the entire contents of which are incorporated herein by reference.

The present invention relates to systems and methods for data manipulation as well as systems that incorporate a data manipulation device.

### BRIEF DESCRIPTION OF THE DRAWINGS

The inventions claimed herein are exemplified in several embodiments. These exemplary embodiments are described in detail with reference to the drawings. These embodiments are non-limiting exemplary embodiments illustrated in several views of the drawings, in which like reference numerals represent similar parts throughout, and wherein:

FIG. 1 depicts a high level functional block diagram of a data manipulation device, according to an embodiment of the present invention;

FIG. 2 depicts a high level functional block diagram of a memory controller for controlling data storage and access in a memory, according to an embodiment of the present invention;

FIG. 3 depicts a high level functional block diagram of a processor deployed in a data manipulation device, according to an embodiment of the present invention;

FIG. 4 depicts a functional block diagram of a backup storage in a data manipulation device, according to an embodiment of the present invention;

FIG. 5 depicts a functional block diagram of a battery system in a data manipulation device, according to an embodiment of the present invention;

FIG. 6 depicts an exemplary organization of a memory, according to an embodiment of the present invention;

FIG. 7 depicts a high level functional block diagram of a data access request handler in relation to various flags and LUN structures, according to an embodiment of the present invention;

FIG. 8 shows exemplary system states and transitions thereof under different operational conditions, according to an embodiment of the present invention;

FIG. 9 depicts an exemplary arrangement of different components of a data manipulation device, according to an embodiment of the present invention;

FIG. 10 illustrates an exemplary arrangement of memory boards and internal organization thereof, according to an embodiment of the present invention;

FIG. 11 shows exemplary arrangement of registered buffers on memory boards, according to an embodiment of the present invention;

FIG. 12 shows exemplary arrangement of phase locked loop clocks on memory boards, according to an embodiment of the present invention;

FIG. 13 depicts exemplary pin shift arrangement between two different memory boards, according to an embodiment of the present invention;

FIG. 14(a) shows an exemplary physical layout of a SCSI controller board SCB, according to an embodiment of the present invention;

FIG. 14(b) shows an exemplary physical layout of a DRAM controller board or DCB, according to an embodiment of the present invention;

FIG. 14(c) shows an exemplary physical layout of memory chips on a memory board, according to an embodiment of the present invention;

FIG. 14(d) shows an exemplary physical arrangement of different boards of a data manipulation device in a compact box, according to an embodiment of the present invention;

FIGS. 14(e) and (f) show different exploded perspective views of an exemplary physical assembly of different boards and components of a data manipulation device, according to an embodiment of the present invention;

FIG. 14(g) and (h) show different perspective views of an exemplary box hosting a data manipulation device with different connection ports, according to an embodiment of the present invention;

FIG. 15(a) and (b) illustrate different exemplary embodiments of storage systems where one or more data manipulation devices are used as high speed disk storage emulators, according to an embodiment of the present invention;

FIG. 16 is a flowchart of an exemplary process, in which a data manipulation device is used to emulate a high speed disk for data storage and access, according to an embodiment of the present invention;

FIG. 17 is a flowchart of an exemplary process, in which a data manipulation device is initialized, according to an embodiment of the present invention;

FIG. 18 is a flowchart of an exemplary process, in which a processor in a data manipulation device receives a data access request and forwards the request to appropriate drive(s), according to an embodiment of the present invention;

FIG. 19 is a flowchart of an exemplary process, in which a data request is handled out of a memory, according to an embodiment of the present invention;

FIG. 20 is a flowchart of an exemplary process, in which a data request is handled from either a memory or a backup storage, according to an embodiment of the present invention;

FIG. 21 is a flowchart of an exemplary process, in which a diagnosis is performed and error messages are recorded in a backup storage, according to an embodiment of the present invention;

FIG. 22 shows an exemplary deployment configuration in which one or more data manipulation devices are deployed as slave processing units to perform high speed data off-loading tasks, according to an embodiment of the present invention;

FIG. 23 shows an exemplary deployment configuration in which a data manipulation device is deployed to assist network switches to perform high speed traffic control and network management processing, according to an embodiment of the present invention; and

FIG. 24 shows an exemplary deployment configuration in which data manipulation devices are deployed to handle high bandwidth data transmission over high speed network connections, according to an embodiment of the present invention.

### DETAILED DESCRIPTION OF SEVERAL EMBODIMENTS

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software or firmware being run by a general-purpose or network processor. Thus, the operation blocks illustrated in the drawings and described below may be special purpose circuits or may be sections of software to be executed on a processor. Data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

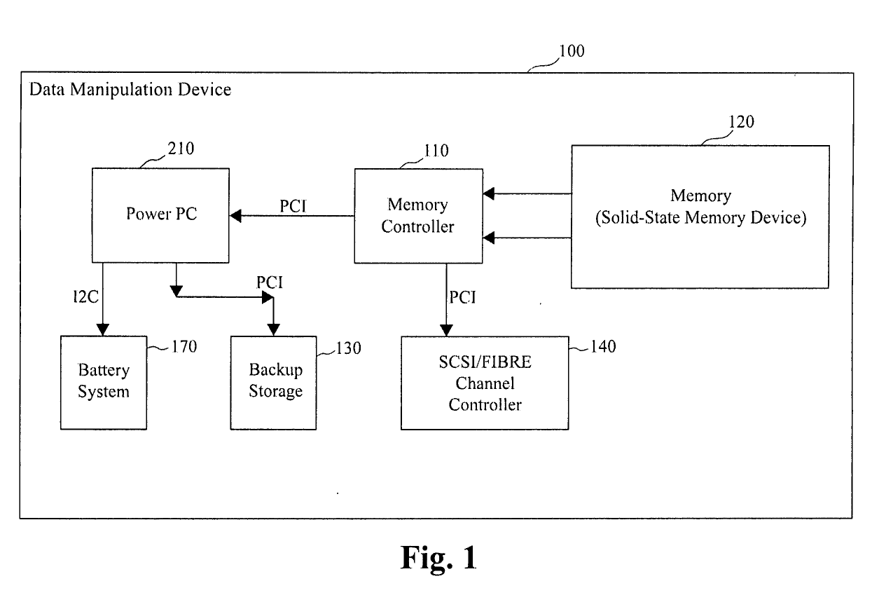

FIG. 1 depicts a high level functional block diagram of a data manipulation device (DMD) 100, according to an embodiment of the present invention. The DMD 100 comprises a channel controller 140, which can be either a SCSI channel controller, Fibre channel controller, on other interface controller available within the art, a memory controller 110 that controls data storage and access of a memory 120, a backup storage system 130, low power CPU such as a Power PC (210) and a battery system 150. The SCSI/Fibre/interface channel controller 140 in the DMD 100 is responsible for interfacing with the outside world. The nature of the interactions between the DMD 100 and the outside world may depend on the purpose the DMD 100 is deployed and the functional role of the DMD 100 in the context of the deployment. For example, the SCSI/Fibre (or other interface within the art) channel controller 140 may interface with one or more host systems when the DMD 100 is deployed to emulate high speed solid state disk storage. In this case, the DMD 100 receives a data request through the SCSI/Fibre channel controller 140 from a host system and then accesses data at a high speed based on what is requested. When the DMD 100 is deployed as a slave data manipulation device to perform designated applications, it may interface, also via its SCSI/Fibre/interface channel controller 140, with a master server that, for example, may invoke the DMD 100 to perform a massive query search in data stored on the DMD 100.

In the DMD 100, the channel controller 140 may provide a common driver to access either SCSI or Fibre channel or other interface to data buses. That is, each implementation of the DMD 100 may deploy either any common interface controller using the same driver. Deployment of any controller may be determined based on where and how the deployed DMD product is to be used.

The common driver may support a SCSI interface that may comply with Ultra320 and have backward compatibility with Fat SCSI, Ultra SCSI, Ultra2 SCSI, and Ultra160 SCSI. A 16-bit parallel SCSI bus may perform 160 mega transfers per second that may yield a 320 Mbytes/second synchronous data transfer rate. The common driver may also support a dual 2-Gbit Fibre Channel (FC) interfaces and provide backward compatibility with 1-Gbit FC. The DMD 100 may also provide a RS-232 interface (not shown in FIG. 1) for a commercial line interface (CLI).

A data request received by the channel controller is directed to the memory controller 110, which then processes the data request. A data request may include a read request or a write request, which may involve, for example, either writing a new piece of data or updating an existing piece of data. Depending on the system state at the time the data request is received, the memory controller 110 may accordingly carry out the data request from appropriate storage(s). For instance, the memory controller 110 may perform the requested data access directly from the memory 120, from the backup storage 130, or from both.

When the data request is completed, the DMD 100 sends a response, through the channel controller 140, back to the underlying requesting host system. A response may include a piece of data read from the DMD 100 based on the request or a write acknowledgment, indicating that data that was requested to be written to the DMD 100 has been written as requested. The response to a read request may also include a similar acknowledgement indicating a successful read operation.

The DMD 100 may be deployed for different purposes. For example, it may be used to emulate a standard low profile 3.5″ high-density disk (HDD). In this case, it may identify itself to the outside world, through a SCSI/Fibre bus, as such a standard device so that the interacting party from the outside world may invoke appropriate standard and widely available devices or drivers to interact with the DMD 100. The DMD 100 may then employ solid state memory 120 to allow the unit to be utilized as a solid state disk (SSD).

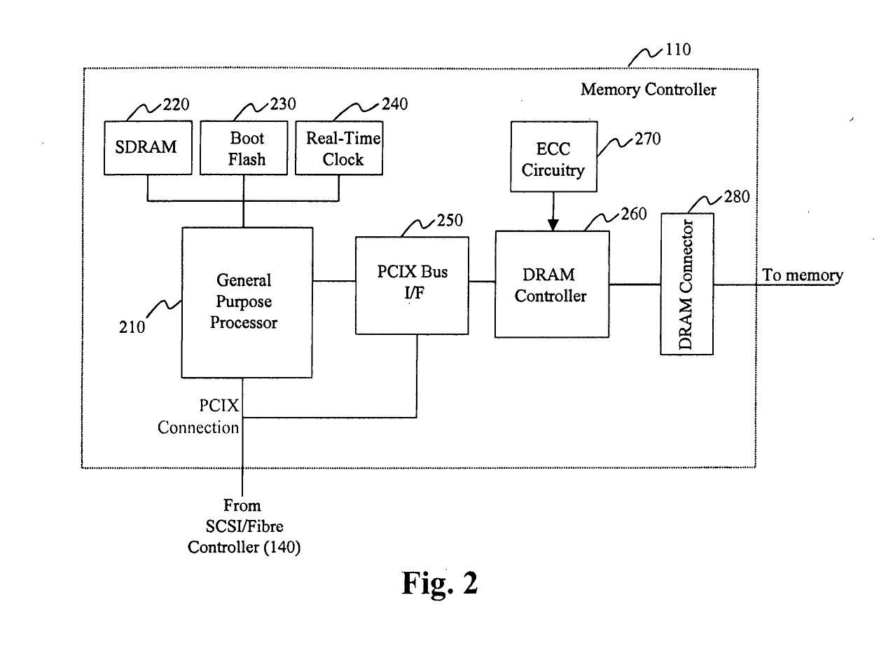

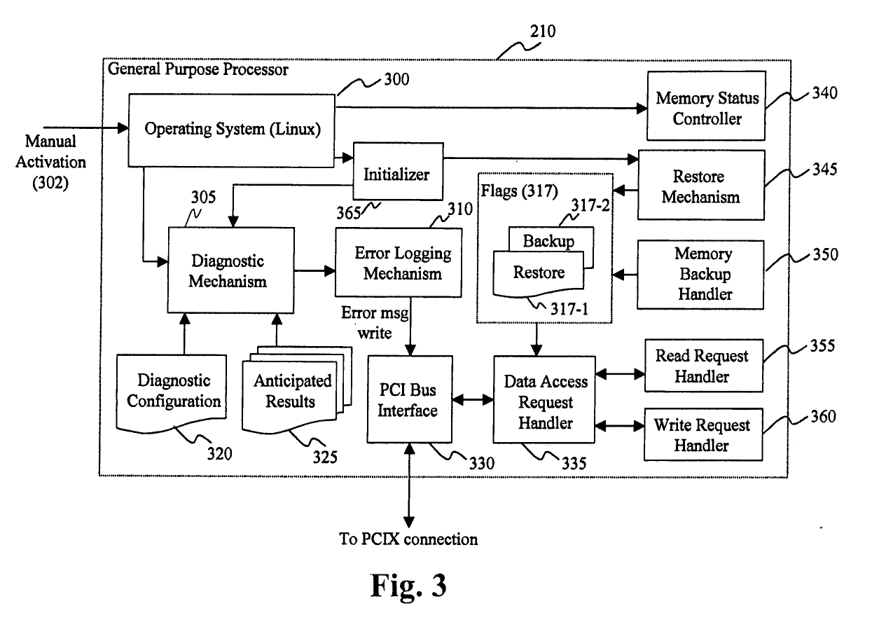

The memory controller 110 controls the operations performed in the memory 120. Under normal circumstances, data requests from host systems are carried out with respect to the memory 120. In certain situations such as when the memory load is not yet completed, data access operations may need to be performed from somewhere other than the memory 120. For instance, when the DMD 100 is in a restore system state, a read request may be performed temporarily from the backup storage 130. In this case, through the Power PC (210), the memory controller 110 may also control data operations performed in the backup storage 130. Details related to the memory controller 110 are discussed with reference to FIGS. 2 and 3.

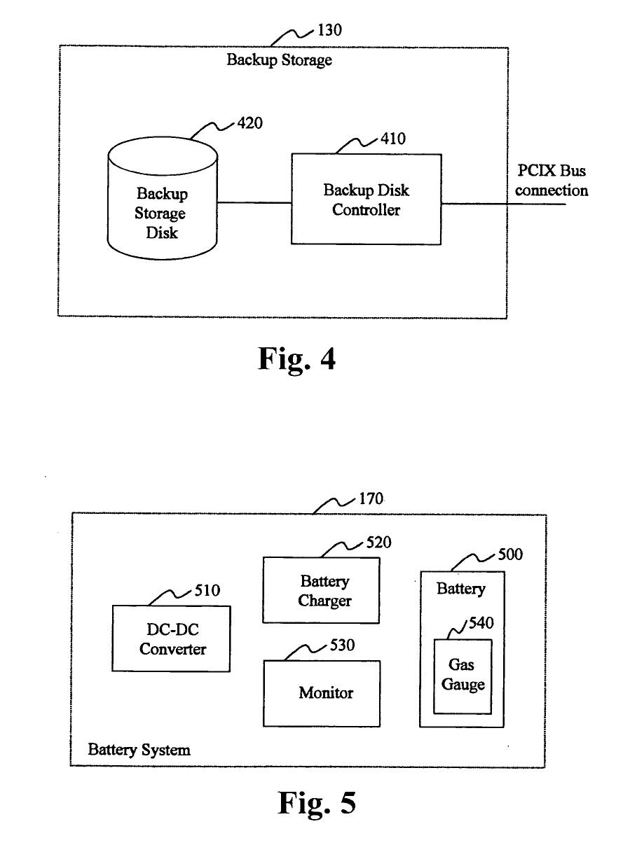

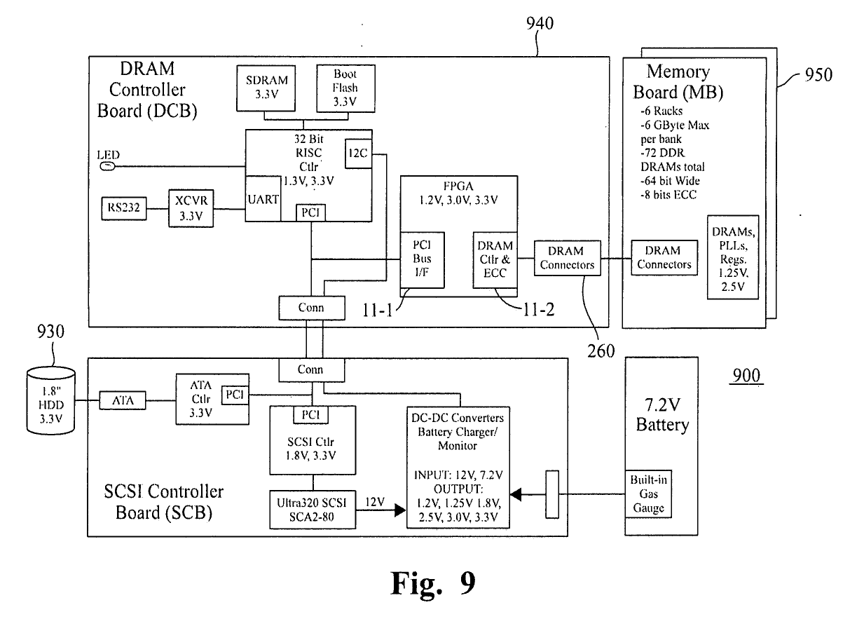

The backup storage 130 in conjunction with battery 170, provides a self-contained and non-volatile backup storage to the DMD 100. Such a storage process may be used to backup data stored in the memory 120 when, for example, power to the DMD 100 is low or down. The backup storage 130 may also be used to store or record diagnostic information obtained during a diagnosis procedure so that such recorded diagnostic information may be retrieved or accessed off-line when it is needed to, for instance, determine system problems. Such a storage space may also be used as a transitional memory space when memory load is not yet completed. Details related to this aspect are discussed with reference to FIGS. 4 and 8.

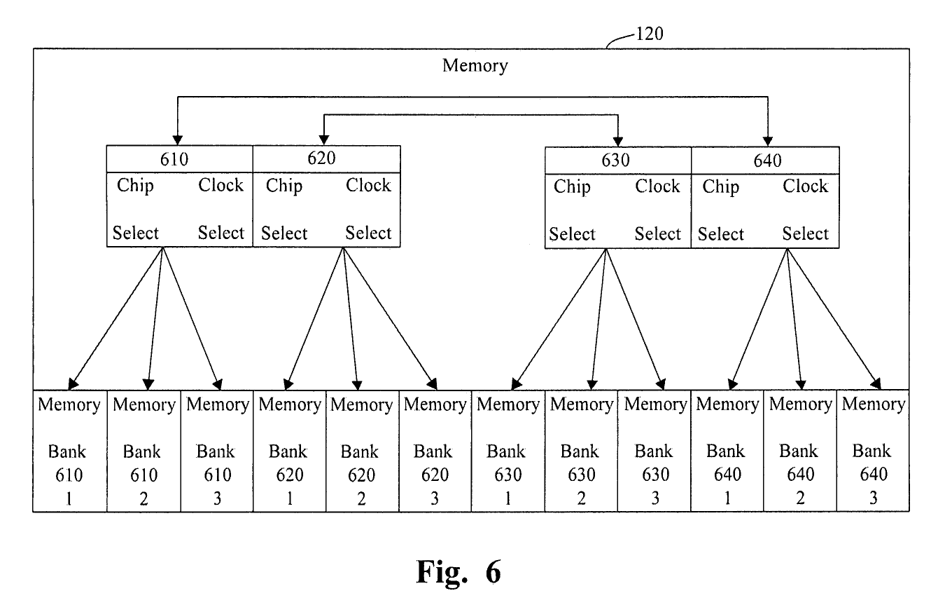

The battery system 170 in the DMD 100 provides off-line power to the DMD 100. The battery system may be crucial in facilitating data back up from the memory into the backup storage 130 when the power is persistently low or down. Details related to the battery system are discussed with reference to FIG. 5.

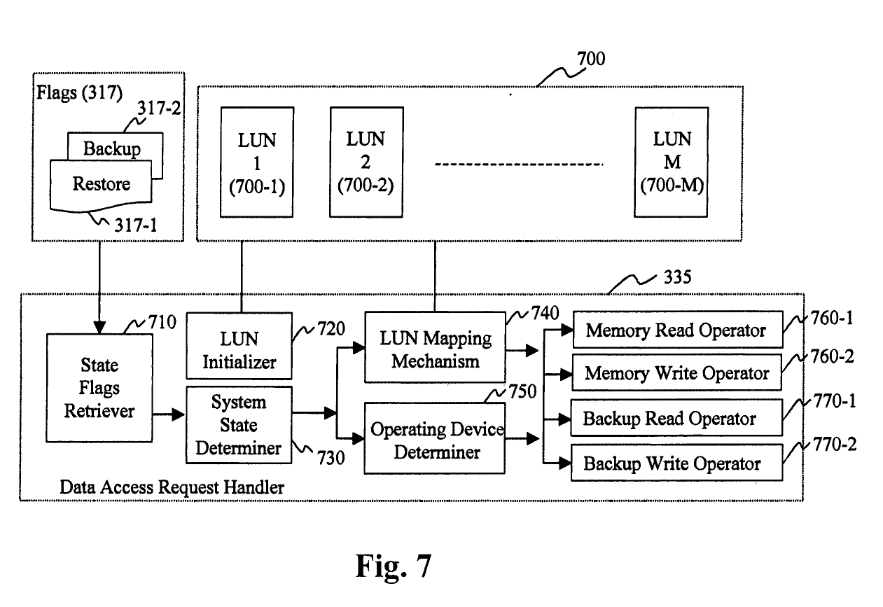

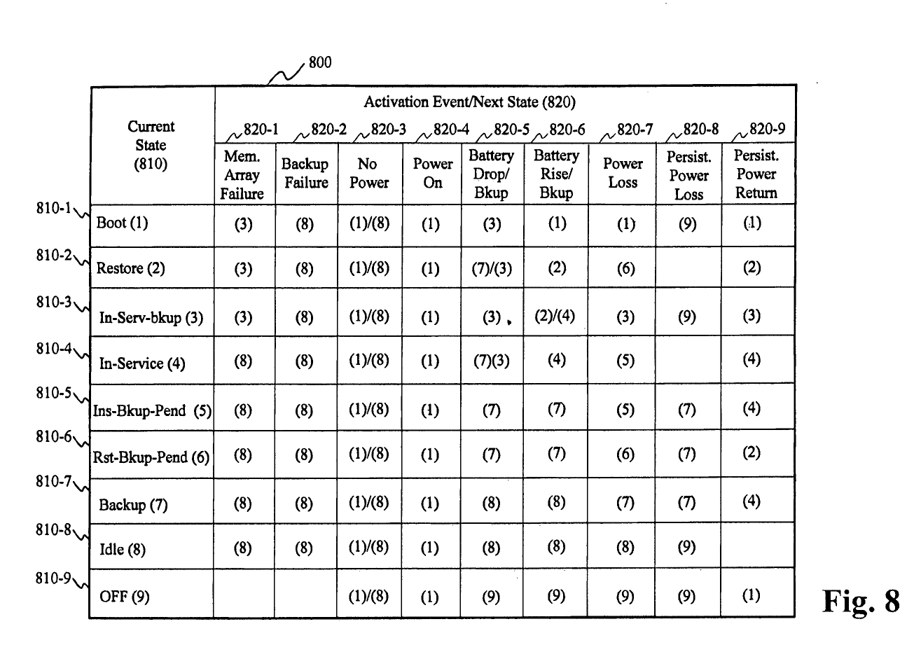

The memory 120 may comprise a plurality of memory banks organized on one or more memory boards. Each memory bank may provide a fixed memory capacity and dynamic random access (DRAM). Different memory banks may be addressed in a coherent manner. The memory 120 may also be organized into a plurality of logic unit number (LUN) structures and each of such structures may support variable block sizes. Memory allocation may be performed by the memory controller 110 according to various criteria. Details related to memory organization are discussed with reference to FIGS. 6 and 7.

FIG. 2 depicts a high-level functional block diagram of the memory controller 110, according to an embodiment of the present invention. The memory controller 110 comprises a processor 210, a PCIX Bus Interface (I/F) 250, a DRAM controller 260 with Error Correcting Circuitry (ECC) circuitry 270, and a DRAM connector 280. The processor 210 may be realized using a commercially available general-purpose, low power central processing unit (CPU). For example, the 400 MHz 32-bit PowerPC 405 GPr micro-controller from IBM Corp. may be used as the processor 210, which has a real time clock 240 capable of 600 MIPS at 400 MHz clock rate. The 32-bit 405 GPr micro-controller (processor 210) has a single device on the processor local bus that provides a certain amount (e.g., 32 MB) of SDRAM (220) with a bus width of 32 bits. The processor 210 may also have its own boot flash device (230) on the local bus that provides a certain amount (e.g., 32 MB) of non-volatile flash memory with a flash data bus width of 16 bits. The real-time clock may be provided for different purposes such as time stamping error logs, long interval timing for battery charge, power loss filtering, etc.

The PCIX Bus I/F 250 may be used to adapt the PCIX bus transfer rate and burst length to the transfer rate and burst length required for the memory 120 (e.g., double data rate synchronous dynamic random access (DDR SDRAM)). The DRAM controller 260 may perform various functions related to memory access. For example, it may provide, through the ECC circuitry 270, single bit error correction and double bit error detection and support 8-bit ECC over the 64 bit data from the memory 120. The DRAM controller 260 may also generate interrupts to the processor 210 whenever it detects a memory error. Furthermore, it may also provide refresh cycles and refresh cycle timing. In one embodiment, the DRAM controller may also carry out power saving strategies, controlled by the processor 210, by sending signals to memory banks to control the memory modes. This will be discussed in detail with reference to FIG. 3. The DRAM connector 280 provides a physical connection between the memory controller 110 and the memory 120.

FIG. 3 depicts a high-level functional block diagram of the processor 210, according to an embodiment of the present invention. The processor 210 employs an operating system 300 installed and running thereon, an initializer 365, a PCIX bus interface 330, a data access request handler 335, a memory status controller 340, a restore mechanism 345, a memory backup handler 350, a read request handler 355, and a write request handler 360. The processor 210 may also include a diagnostic mechanism 305, which is responsible for performing various diagnostic routines, and an error logging mechanism 310, which is responsible for writing error messages to the backup storage 130.

The operating system 300 may be a commercially available product such as Linux. Upon a start-up (or reset) of the system, the operating system 300 may be loaded from the backup storage 130. Upon being booted, the operating system 300 may invoke the initializer 365 to perform various initializations. The initializer 365 may be responsible for initializing the memory arrays, the backup storage drive, and the SCSI/Fibre/other interface system. Boot images for these devices may be downloaded to the respective device during the initialization. To ensure that the initialized devices are functioning properly, the initializer 365 may also invoke the diagnostic mechanism 305 to perform certain diagnostic routines.

The diagnostic mechanism 305 may perform diagnostic routines according to some pre-determined diagnostic configuration (320). Such configuration may be dynamically revised to satisfy application needs. When components are added or removed from the DMD 100, the diagnostic configuration may need to be changed accordingly. For example, if more memory boards are added, the configuration for diagnosis may reflect the additional device.

When the diagnostic mechanism 305 performs diagnosis routines, it may send a signal to a device, configured to be tested, and then compare a response from the tested component with some anticipated result 325. If the measured result differs from the anticipated result, an error message may be generated and the error logging mechanism 310 may be invoked to record the diagnostic information in the backup storage 130. In some embodiments, the diagnostic mechanism 305 may also be invoked through manual activation (302) via the shell of the operating system 300.

If the diagnosis is completed successfully, the initializer 365 may then register to receive signals from various drivers and invoke the restore mechanism 345 to perform restore operations, including copy data from the backup storage 130 to the memory 120. When the restore operation is completed, the initializer 365 may then change the system state to an appropriate state for data access operations.

The system state of the DMD 100 may be signified through a plurality of flags 315. For example, when the initializer 365 changes the system state to restore, it may set a “restore” flag 315-1 indicating the system is restoring data or a memory load is being performed. When the restore mechanism 345 completes the memory load, it may reset the same flag 315-1, indicating that the memory load is completed. Similarly, if the system is performing a backup operation (e.g., moving data from the memory 120 to the backup storage 130), a “backup” flag may be set. Different system states may indicate where data is currently stored. Therefore, depending on the system state, a data request may be handled differently.

The PCIX bus interface 330 is used to communicate with the controller 140, the backup storage 130, and the memory arrays 120. When the controller 140 forwards a data request from a host system to the memory controller 110, the data request is channeled through the PCIX connection between the controller 140 and the PCIX bus interface 330 of the processor 210.

Upon receiving the data request, the PCIX bus interface 330 sends the data request to the data access request handler 335. The data access request handler 335 may analyze the request and then activate the read request handler 355, if the request is a read request, or the write request handler 360, if the request is a write request. Depending on the system state, the read and write request handlers 355 and 360 may operate differently. For example, if a data read request is received before a restore operation (memory load) is completed, the read request handler 355 may direct a read instruction to the backup storage 130 instead of sending such an instruction to the memory 120. If a data write request is received before memory load is completed, the write request hander 360 may send a write instruction to both the memory 120 and the backup storage 130 and then receive an acknowledgement only from the backup storage 130.

The memory backup handler 350 is responsible for carrying out memory backup operations. This handler may be activated in certain scenarios such as when a persistent power loss is detected or when battery power drops to a certain level. When it is activated, it may set the “backup” flag, indicating a system state transition to a backup system state. Under this system state, the DMD 100 may refuse a data request received from a host system. This system state may not change until, for example, a steady power return is detected.

The memory status controller 340 is responsible for carrying out a power saving scheme of the memory banks. In one embodiment of the present invention, to reduce power consumption and hence heat generation, the DMD 100 employs a power saving scheme in which different memory banks are put into different modes, some of which yield lower power consumption. The implementation of the power saving scheme may depend on the system state. In some embodiments, when the system is in a “normal” or “restore” mode, the processor 210 may put, through the memory status controller 340, all memory banks, except one active bank, into a “sleep” or “power down” mode. With DDR SDRAM memory, the wake up time can be about 3 microseconds (compared with 30 microsecond for SDR SDRAM). Such a significantly shorter wake up time facilitates higher speed storage accesses. While in the “sleep” mode, an inactive memory bank may still receive clocking. The power saving scheme is also applied to special DDR memory 120 chips which have been developed to increase storage capacity density in the space of a standard size DDR chip form factor. This special DDR memory chip is developed by the stacking of multiple memory die in such a manner as to allow each die to be address as a single chip though it is physically located inside a single form factor.

When the system is in “backup” mode, the processor 210 may further reduce power consumption by stopping the sending of clocking to the inactive memory banks and putting the inactive memory banks in a “self-refreshing” mode of operation. Although it may take longer (about 20 microseconds) to exit the “self-refreshing” mode, such a longer wake-up time may be acceptable in a backup situation.

FIG. 4 depicts a functional block diagram of the backup storage 130, according to an embodiment of the present invention. The backup storage 130 includes a backup storage disk 420 and a backup disk controller 410. The controller 410 is connected to the PCIX bus and is responsible for controlling data storage and access to/from the disk 420. The disk may be implemented as a rotating disk or a high-density disk (HDD). The capacity of the disk may be determined based on application needs. The backup storage 130 may be used not only for backup purposes but also for other purposes such as being used as memory when a memory load is not yet completed, recording diagnostic information or error messages, or mirroring data written to DDR 120 memory.

In conventional systems, a typical restoration period may range from 1 to 2 minutes per gigabyte. During the restoration period, systems typically cannot respond to any data request. This causes a delay. In some embodiments of the present invention, since the backup storage 130 is used as the memory before a memory load is completed, it eliminates the delay. In addition, in one embodiment, the DMD 100 is running under a Linux operating system with its own SDRAM and this further improves the speed of this operation. For instance, for 12 Gigabytes of memory, it can take about 5 minutes to complete the operation. Details related to using the backup storage 130 as memory prior to completion of memory load are discussed with reference to FIGS. 8, 15, and 19.

The backup storage 130 may also be used to log error messages in the event of failure and diagnostic information obtained when diagnostic routines are carried out. In the event of system failure, the error information logged in the backup storage 130 may be removed for assessing the cause of the failure.

FIG. 5 depicts a functional block diagram of the battery system 150, according to an embodiment of the present invention. The battery system 150 comprises a battery 500 with a built-in gas gauge 540, a DC-DC converter 510, a monitor 530, and a battery charger 520. The monitor 530 is responsible for monitoring the condition of the battery 500 through the gas gauge 540. The monitoring results may be used to determine whether the system state needs to be changed. For example, when the battery power is persistently going down and reaches a certain low threshold, the system state may be changed from a “normal” state to a “backup” state.

The battery 500 may output certain voltages such as 7.2 v. The battery charger 520 is responsible for recharging the battery when it is needed. The DC-DC converter 510 is responsible for converting the battery output voltage, e.g., 7.2 v or SCSI power of 12 v, into different voltages needed in the system. For example, the DC-DC converter 510 may take input voltage of 7.2 v or 12 v and convert into 1.2 v, 1.25 v, 1.8 v, 2.5 v, 3.0 v, or 3.3 v.

In some embodiments of the present invention, the battery system 150 may be controlled by the general purpose processor 210 in the memory controller 110. A monitoring scheme may be carried out under the control of the general purpose processor 210 for the purpose of prolonging the life of the battery. Under this scheme, the monitor 530 monitors the power level of the battery 500. The observed power level is sent to the general purpose processor 210. When the power level reaches certain level (e.g., full power), the general purpose processor 210 may stop the charging until the power falls to a certain lower level (e.g., 90%). This prevents the battery to be charged continuously when it is already at a full power level (which is known to shorten the life of the battery). In addition, when the monitored power level reaches a low threshold, the general purpose processor 210 may cause the device to automatically shut down.

FIG. 6 depicts an exemplary organization of the memory 120, according to an embodiment of the present invention. The memory 120 may comprise one or more memory boards. Each of the memory boards may include a plurality of memory banks. For example, one memory board may include memory banks 610-1, 610-2, 610-3, 620-1, 620-2 and 620-3. Another memory board may include memory banks 630-1, 630-2, 630-3, 640-1, 640-2 and 640-3.

Each memory board may also include a plurality of registers and clocks such as phase locked loop (PLL) clocks. Thus, the one memory board includes chip select/clock select devices 610 and 620 to provide clocking to memory banks 610-1, 610-2, 610-3 and 620-1, 620-2 and 620-3, respectively. The other memory board includes chip select/clock select devices 630 and 640 to provide clocking to memory banks 630-1, 630-2, 630-3 and 640-1, 640-2 and 640-3.

The memory 120 may also be logically organized into a plurality of LUN structures. The DMD 100 may support multiple LUN structures capable of handling varying block sizes. Different LUN structures may facilitate different block sizes. In addition, each LUN structure may also support different block sizes. With such capabilities, the DMD 100 may appear to have multiple storage devices, each with a certain block size. This enables the DMD 100 to interface with host systems that require different block sizes.

When variable block sizes are supported, a data request from a host system with a required block size may be first mapped to a LUN structure that has a matching block size. FIG. 7 depicts a high-level functional block diagram of the data access request handler 335 in relation to various flags 315 and multiple LUN structures 700, according to an embodiment of the present invention. As discussed earlier, a data request may be processed in different internal storage media (e.g., out of the memory 120, out of the backup storage, or both) and a determination may be made based on the system state. In addition, depending on where the data request is being handled, appropriate LUN structures may be accordingly identified.

In the exemplary embodiment illustrated in FIG. 7, the memory is organized into, for example, M LUN structures, LUN 1 700-1, LUN 2 700-2, . . . , and LUN M 700-M. The data access request handler 335 comprises a system flags retriever 710, an LUN initializer 720, a system state determiner 730, an LUN mapping mechanism 740, an operating device determiner 750, and various data access operators, including, for instance, a memory read operator 760-1, a memory write operator 760-2, a backup storage read operator 770-1, and a backup storage write operator 770-2.

The LUN initializer 720 may be responsible for initializing the multiple LUN structures 700. For example, when the system is initially set up, all the LUN structures may be set with a uniform or a standard block size (e.g., 512 bytes) and this initial block size may later be changed to satisfy data requests with different block size values. For instance, some systems (e.g., Unisys products) may operate on a block size of 180 bytes and some (e.g., Tandem products) may operate on a block size of 514 bytes.

Upon receiving a data request, the data access request handler 335 may first access, via the system flags retriever 710, the flags 315, which indicate the operational status of the system. The system flags retriever 710 may then forward the retrieved flag values to the system state determiner 730 to identify a current system state. Based on the determined system state, the operating device determiner 750 may decide the device(s) (e.g., the memory 120 or the backup storage 130 or both) from/to where the read/write operation is to be performed. For example, when the system flags indicate a normal system state, the operating device determiner 750 may select the memory 120 as the operating device, i.e., a data request, either a read request or a write request, will be handled out of the memory 120.

When the system flag “restore” is raised indicating that memory load is not yet completed, the operating system determiner 750 may select to handle a read and a write request differently. For example, a read request may be carried out from the backup storage 130 because the data to be read may still be in the backup storage 130. As for a write request, the system may write the same data to both the memory 120 and the backup storage 130 in order to ensure data integrity. The system state determined by the system state determiner 730 may also be used by the LUN mapping mechanism 740 to map the data request to a particular LUN structure.

Based on the decision in terms of from/to where the read/write operation is to be carried out, the operating device determiner 750 may invoke an appropriate data request operator. For example, when a data read/write request is to be processed out of the memory 120, the memory read/write operator 760-1/760-2 may be activated. When a data read/write request is to be processed out of the backup storage 130, the backup read/write operator 770-1/770-2 may be activated.

In addition, based on the LUN mapping result, the LUN mapping mechanism 740 may also supply relevant information to the invoked operator. For example, the LUN mapping mechanism 740 may forward the information related to the mapped LUN structure to the activated operator.

An activated operator may send some data operation instructions to an appropriate device and then receive a response from the device after the data operation is completed. Such a response may include the return of a piece of data (e.g., when data is read), an acknowledgement (e.g., a write acknowledgement), or an error message (e.g., from either a read operation or a write operation). The response is from a respective device to which the operation instructions are sent. For example, to read a piece of data to satisfy a corresponding read request, a read operator (either the memory read operator 760-1 or the backup read operator 770-1) may send a read instruction with an appropriate address (e.g., within a specific LUN structure determined by the LUN mapping mechanism 740) to the underlying operating device. When the read is completed, the read operator may receive the data read from the operating device with or without some acknowledgement message. The received data and the acknowledgement, if any, may then be sent to the PCIX bus interface 330 (see FIG. 3) to be forwarded to the requesting host system. When an error has occurred during the operation, the read operator may also receive and forward the error message.

When a write operation is involved, depending on whether the operation is handled out of the memory 120 only (e.g., in a normal system state) or out of both the memory 120 and the backup storage 130 (e.g., in a restore system state), the write operator may behave differently. In a normal system state, the memory write operator 760-2 is invoked for a write operation. The memory write operator 760-2 may first send a write instruction with data to be written and then wait to receive either an acknowledgement or an error message from the memory 120. Upon receiving a response, the memory write operator 760-2 forwards the received information to the PCIX bus interface 330.

In some other system states (which will be discussed with reference to FIG. 8 below), a write operation is performed in both the memory 120 and the backup storage 130. In this case, both the memory write operator 760-2 and the backup write operator 770-2 are invoked. Both write operators send the data to be written with write instructions (e.g., where to write) to their respective operating devices (i.e., the memory 120 and the backup storage 130). Since the memory 120 may operate at a much higher speed than the backup storage 130, only the backup write operator 770-2 may be configured to forward the write acknowledgement or error message received from the backup storage 130 to the PCIX bus interface 330, even though the memory write operator 760-2 may also receive such information from the memory 120.

FIG. 8 shows various exemplary system states and transitions thereof under different operational conditions in the DMD 100, according to an embodiment of the present invention. The state transition table 800 contains rows and columns. Rows correspond to current system states 810 and columns correspond to events or conditions 820 under which a current state transits to a different state or remains in the same system state. Each entry in the table 800 corresponding to a particular row and a particular column represents the next system state, given the current system state represented by the row and the event/condition represented by the underlying column.

In the table 800, there are 9 exemplary system states, including a boot state 810-1, labeled as (1), a restore state 810-2, labeled as (2), a in-service-backup state 810-3, labeled as (3), a in-service state 810-4, labeled as (4), a in-service-backup-pending state 810-5, labeled as (5), a restore-backup-pending state 810-6, labeled as (6), a backup state 810-7, labeled as (7), an idle state 810-8, labeled as (8), and an off state 810-9, labeled as (9). There are various events/conditions which may trigger system state transitions, including the event of memory array failure 820-1, backup failure 820-2, no power 820-3, power on 820-4, battery drop/backup 820-5, battery rise/backup 820-6, power loss 820-7, persistent power loss 820-8, and persistent power return 820-9.

Each system state indicates a particular system operational condition. For example, the boot state (1) indicates that the DMD 100 is going through a booting process triggered by, for example, power on, reset, or via some software means. The restore state (2) indicates that the DMD 100 is restoring data from the backup storage to the memory or is simply loading the memory. The in-service-backup state (3) indicates that the memory 120 is not functioning properly (due to, for instance, memory failure, or insufficient battery for backup) and a data request will be serviced from the backup storage. The in-service state (4) indicates that the DMD 100 is operating under a normal situation. That is, all data requests are handled out of the memory 120.

The in-service-backup-pending state (5) may indicate a situation in which a data request is serviced but with a pending backup. That is, although data requests are still handled out of the memory 120, there exists some condition (e.g., power drop) that is being monitored and that may trigger a backup procedure in the near future. The restore-backup-pending state (6) may indicate that the system is performing a memory load (restoring data from the backup storage to the memory) and some existing condition/event (e.g., power loss) may trigger a backup procedure in the near future if the condition persistently gets worse (e.g., persistent power loss). The backup state (7) simply indicates that the DMD 100 is performing a backup procedure by moving data from the memory 120 to the backup storage 130. The idle state (8) indicates that the system is currently idle and not accepting any data request. The off state (9) indicates that the DMD 100 is currently off.

Each system state may cause the DMD 100 behave differently in terms of how to handle a data request. For example, in system states in-service (4) and in-service-backup-pending (5), a data request is always serviced from the memory 120. In system states restore (2), in-service-backup (3), and restore-backup-pending (6), a data request may be serviced from either the memory 120 or from the backup storage 130 or both, depending on the nature of the request and the location of the data requested. In system states boot (1), backup (7), idle (8), and off (9), no data request is serviced.

System states change under certain conditions/triggering events. Given a fixed current state, the DMD 100 may transit to different system states when different events occur. For example, at the boot state (1), if memory failure occurs (820-1), the system state transits from boot state (1) to the in-service-backup state (3). That is, all data requests will be handled out of the backup storage 130 due to the memory array failure. If a backup storage 130 failure occurs (820-2) during booting, the system state may transit from a boot state (1) to an idle state (8) because the boot process cannot go further without the backup storage 130. If the current system state is normal (in-service state (4)) and a power loss is detected (820-7), the system state may transit to the in-service-backup-pending state (5). In this state, although the system is still in service, there is a possible pending backup. In this state, if the power loss persists (820-8), the system state further transits to the backup state (7). There are certain cells in the table 800 that have blank entries indicating that, given the current state, the underlying event represented by the column does not apply. For example, when the system is in an off state, certain events such as memory array failure 820-1 and backup storage failure 820-2 will not affect the system state.

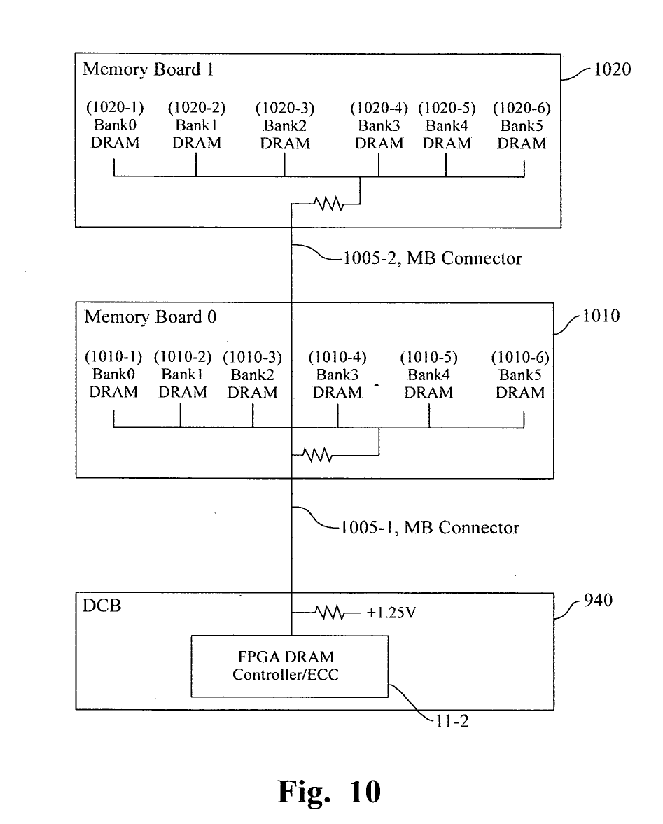

FIG. 9 depicts an exemplary organizational arrangement 900 of different components of the DMD 100, according to one embodiment of the present invention. The exemplary organizational arrangement 900 includes five separate physical parts, including a SCSI/Fibre controller board (SCB) 910, a DRAM controller board (DCB) 940, a memory board (MB) 950, a high-density disk 930 providing the backup storage space, and a battery 920.

Some components of the same logical organization discussed earlier may be grouped on different boards. For example, the backup storage disk controller 410 may be realized using an at-attachment (ATA) controller (7), which may be arranged physically separate from the backup storage disk 930 (e.g., implemented using a Toshiba 1.8″ 20 GB high density disk (labeled as 9) in the exemplary arrangement shown in FIG. 9. Similarly, the DC-DC converter 510 (see FIG. 5), the battery charger 520, and the monitor 530 may be arranged on the SCB 910, separate from the battery 500 and the gas gauge 540. The exemplary arrangement may be made based on factors other than the logical or functional organization considerations such as size, heat consumption, and whether a component needs to be arranged at a location so that it can be easily replaced. Alternatively, or in addition, the physical organizational arrangement may be designed based on considerations related to the compactness of the entire system.

The SCSI/Fibre controller board (SCB) 910 includes an ATA controller chip 7, the SCSI/Fibre controller chip 6, and a power manager and converter chip 3 that contains a DC-DC converter, a battery charger, and a monitor. The DRAM controller (DCB) 940 includes a general processor chip (e.g., a 32 bit 405 GPr) 12, a SDRAM chip 16, a boot flash memory 17, a real-time clock 18, and a field programmable gate arrays (FPGA) chip 11 programmed as both the PCIX bus I/F 11-1 and the DRAM controller with ECC circuitry 11-2 (discussed with reference to FIG. 2).

Each board may also contain different parts that facilitate connections among different boards and components. For example, the SCB 910 includes an ATA connector 8 facilitating the connection between the ATA controller chip 7 and the backup disk 9, a PCIX connector 10 facilitating the PCIX connection between the SCB 910 and the DCB 940, a SCSI/Fibre connector 2 providing physical connections between the SCSI/Fibre controller and the SCSI/Fibre backplane (1), and a battery connector 4 connecting the SCB 910 to the battery 5. Similarly, the DCB 940 includes a counterpart PCIX connector 10 facilitating the connection to the PCIX connector on the SCB 910, a DRAM connector 19 facilitating the connection between the DRAM controller 11-2 and the memory board 950, an RS232 connector providing a serial connection point between the outside and the DMD 100, LED lights 14 providing a means to show system status and activity, and a reset button 15 facilitating the need for resetting the system from outside.

According to one embodiment, the FPGA 11 is connected directly with the PCIX connector 10. This enables the DMD 100 to perform data transfers through its on-board FPGA to accomplish high speed storage access without going through the general processor 12. In addition, since the PCIX connector 10 is also connected to the SCSI controller 6, the FPGA 11 can transfer data directly from/to outside sources without going through the general processor 12. This makes the storage not only accessible at a high speed but also shared as well. Furthermore, since the general processor 12 can be implemented using a commercially available CPU deployed with commercial operating system (e.g., Linux), the DMD 100 is a full-fledged computer, which is capable of supporting various applications normally run on conventional general-purpose computers. In this case, applications may run on the general processor 12 and data necessary for the applications may be transferred to the SDRAM of the processor 12.

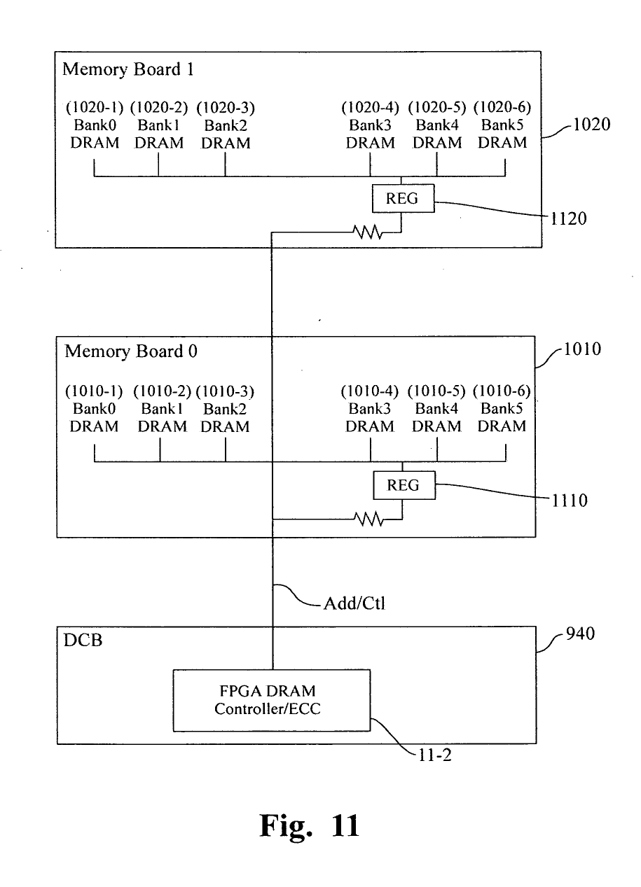

FIGS. 10-13 illustrate an exemplary arrangement of memory boards and their internal organization, according to an embodiment of the present invention. In one embodiment, the memory 120 may comprise one or more memory boards, each of which may include three or six memory banks. Different memory banks within a memory board and different memory boards may be connected in certain fashion to facilitate uniform addressing and clocking. FIG. 10 shows how two exemplary memory boards, a memory board 0 1010 and a memory board 1 1020, are connected with the DRAM controller on the DCB 940. The memory board 0 1010 comprises six memory banks, a bank 0 1010-1, a bank 1 1010-2, a bank 2 1010-3, a bank 3 1010-4, a bank 4 1010-5, and a bank 5 1010-6. The six banks are linked together and connected to the DCB 940 through a memory board connector 1005-1. Similarly, the memory board 1 1020 includes six memory banks, a bank 0 1020-1, a bank 1 1020-2, a bank 2 1020-3, a bank 3 1020-4, a bank 4 1020-5 and a bank 5 1020-6. The six banks on the memory board 1 1020 may be similarly connected together and to the memory board 0 1010 via a memory connector 1005-2. The memory board 1 1020 is connected to the DCB 940 through the memory board 0 1010.

The memory board connectors 1005-1 and 1005-2 may enable different types of signal passing. For example, it may allow data to pass through. It may also enable address information to pass through. In addition, it may allow control signals to pass through. In some embodiments, memory board connectors contain a 72-bit data bus with 64 bits data and 8 bits ECC, data strobes, and data mask signals. They may be routed in a similar fashion. The memory board connectors may also include an address bus and additional paths for control signals. Address and control signals may terminate on each board by a register buffer, which may be clocked by a clock specifically for the board.

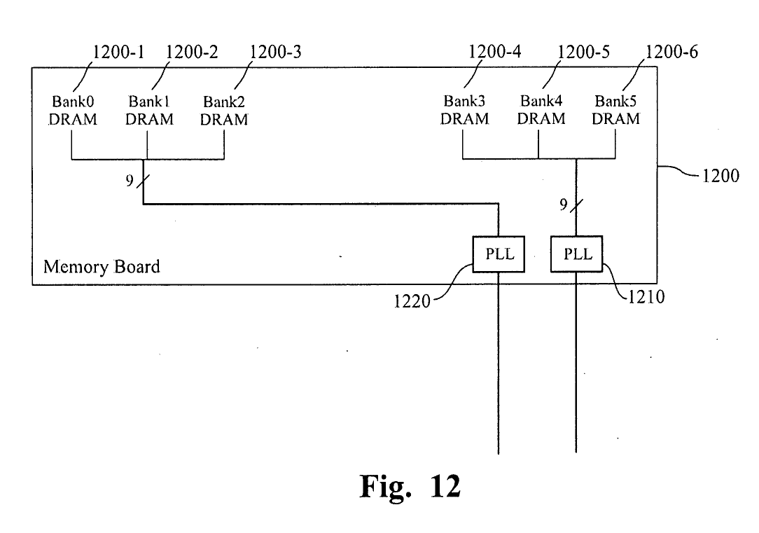

FIG. 11 shows an exemplary arrangement of register buffers in memory boards, according to an embodiment of the present invention. In FIG. 11, each memory board has one register buffer. The memory board 0 1010 has a register buffer 1110 and the memory board 1 1020 has a register buffer 1120. Each may be clocked differently to intercept address and control signals designated to the underlying memory board. Each memory board may use a different clock (CK), clock enable (CKE) signal, and chip select (CS) signal. Each memory bank may have separate CKE and CS signals. Each memory board may have one or more clocks, each of which may be implemented as a phase locked loop (PLL) clock.

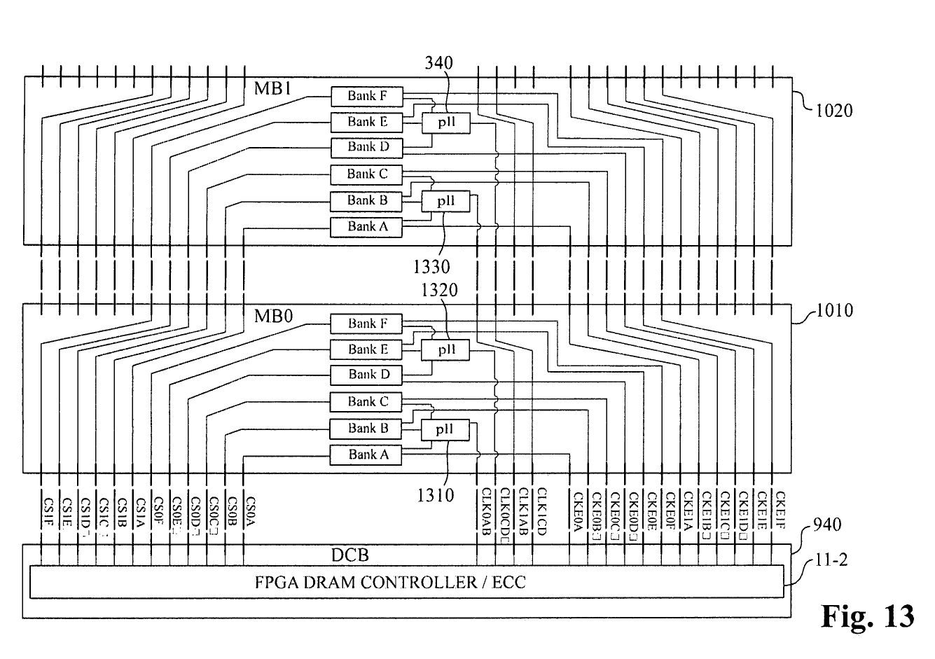

FIG. 12 shows an exemplary arrangement of PLL clocks in memory boards, according to an embodiment of the present invention. In the illustration, a memory board 1200 has two PLL clocks, 1210 and 1220, each of which is responsible for, for example, three memory banks. In the illustrated embodiment, PLL clock 1210 is responsible for clocking bank 3 1200-4, bank 4 1200-5 and bank 5 1200-6, and PLL clock 1220 is responsible for clocking bank 0 1200-1, bank 1 1200-2 and bank 2 1200-3.

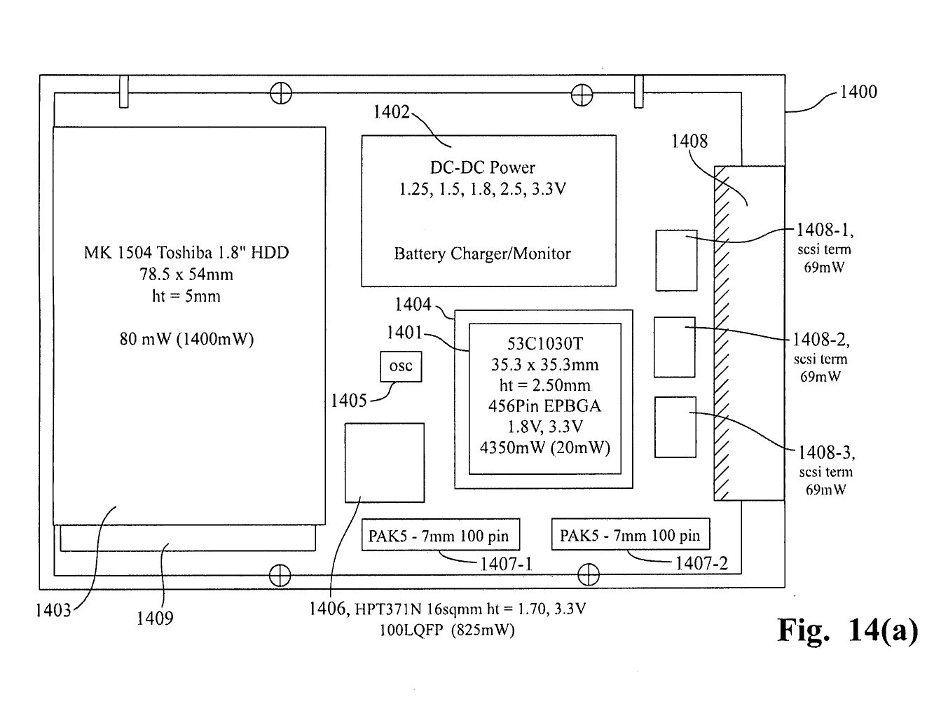

To accommodate routing signals through a DCB-MB-MB traverse, a memory board may be designed to facilitate pin shift. One exemplary pin shift scheme between two memory boards is illustrated in FIG. 13, according to an embodiment of the present invention. To route signals between two memory boards with six memory banks (A, B, C, D, E and F), each of the memory boards may have 28 pins on each side. Among the 28 pins used to connect the memory board 0 1010 to the DCB 940, 14 pins are for signal routing between the DCB 940 and the memory board 0 1010 and the other 14 pins are for signal routing between the DCB 940 and the memory board 1 1020.

Among the first set of 14 pins dedicated for connecting to the memory board 0 1010, 6 pins are for CKE signals for each of the six memory banks (CKE0A, CKE0B, CKE0C, CKE0D, CKE0E and CKE0F), 6 pins are for CS signals for each of the six memory banks (CS0A CS0B, CS0C, CS0D, CS0E and CS0F), and 2 pins are for clocking the two PLL clocks where CLK0AB for clocking a PLL 1310 responsible for banks A, B and C, and CLK0CD for clocking a PLL 1320 responsible for banks D, E and F. These pins are located at (starting from the right most as the first position) positions 7-12 (for CKE0A-CKE0F), 15-16 (for CLK0AB and CLK0CD), and 17-22 (for CS0A-CS0F).

The remaining 14 pins are for connecting the DCB 940 and the memory board 1 1020. Six pins at positions 1-6 are for the clock enable signals, CKE1A-CKE1F, of the six banks on the memory board 1 1020, two pins at positions 13-14 are for the two clocking signals, CLK1AB and CLK1CD, for two PLL clocks 1330 and 1340 (responsible for clocking banks A, B, C, D, E and F, respectively, of the memory board 1 1020), and another six pins at positions 23-28 are for chip selections signals, CS1A-CS1F, corresponding to the six banks on the second board 1020. Signals dedicated to the second memory board 1020 are routed through the first memory board 1010 to arrive at the same pin positions from where the corresponding signals are routed into the first memory board 1010. That is, the clock enable signals CKE1A-CKE1F are routed into the memory board 1 1020 at positions 7-12 (same as the positions for CKE0A-CKE0F), the clocking signals CLK1AB and CLK1CD are routed into the memory board 1 1020 at positions 15-16 (same as for CLK0AB and CLK0CD), and the chip selection signals CS1A-CS1F are routed into the memory board 1 1020 at positions 17-22 (same as CS0A-CS0F).

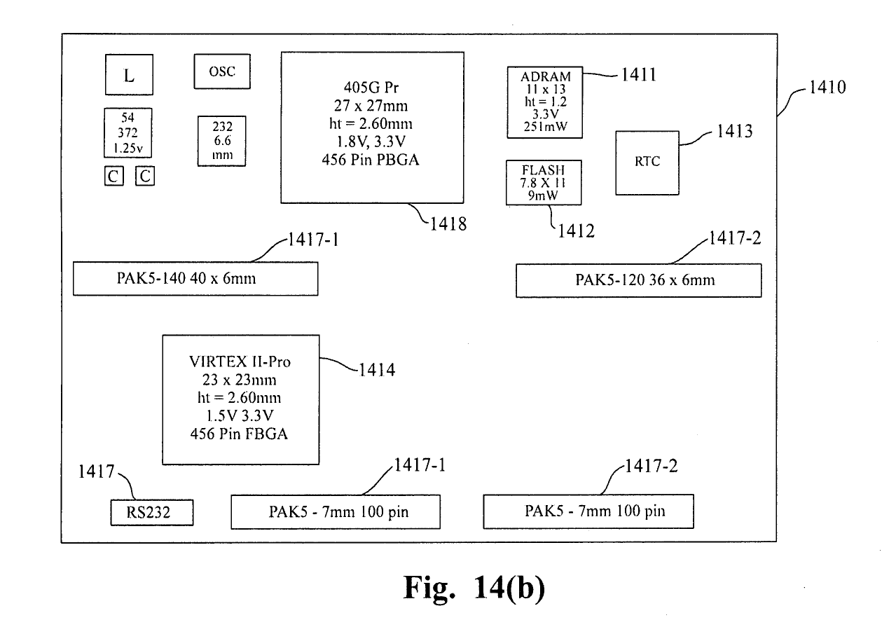

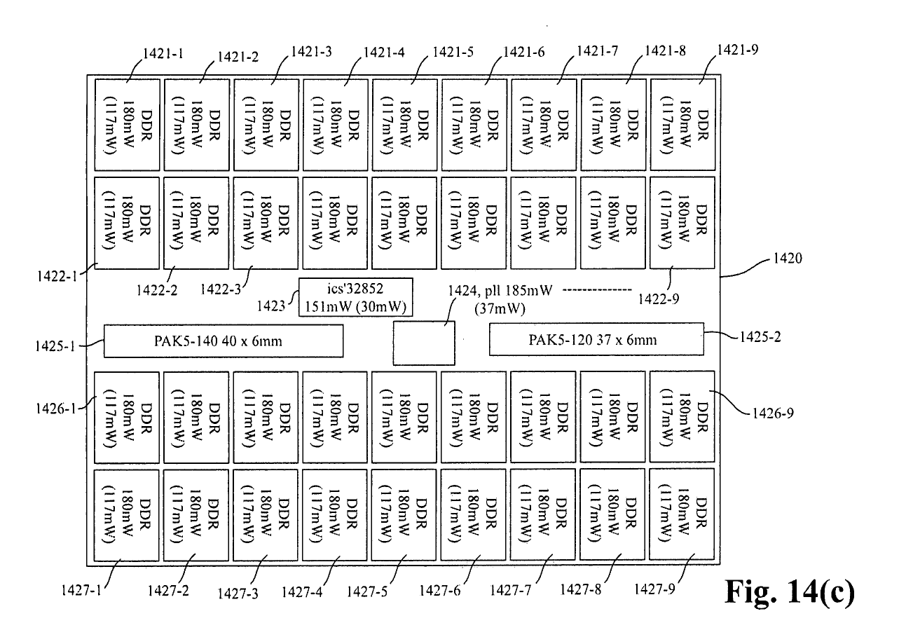

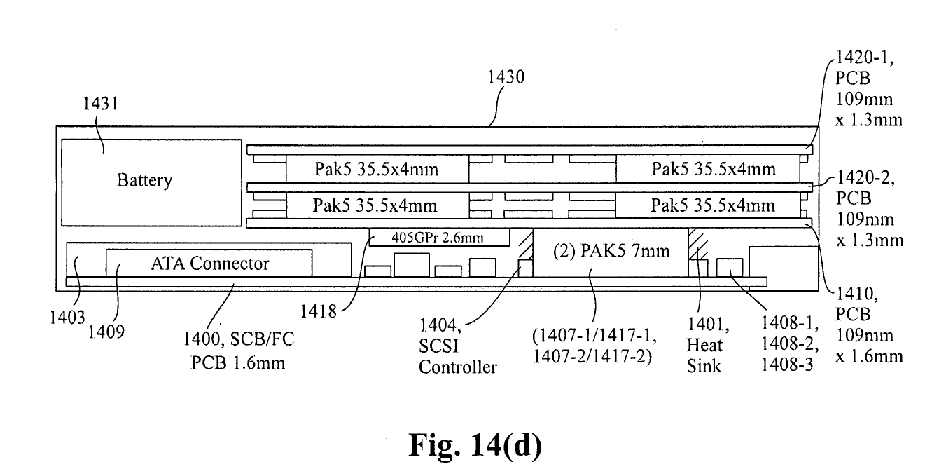

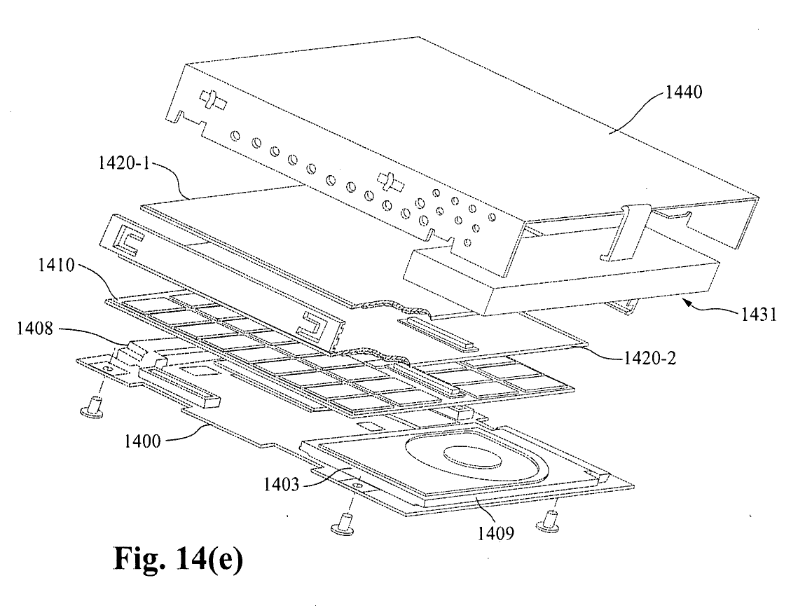

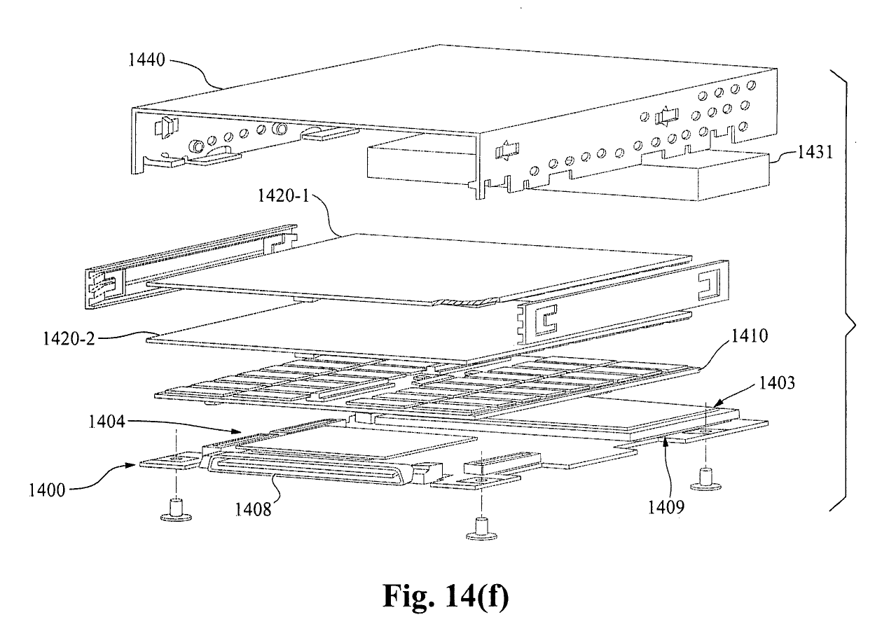

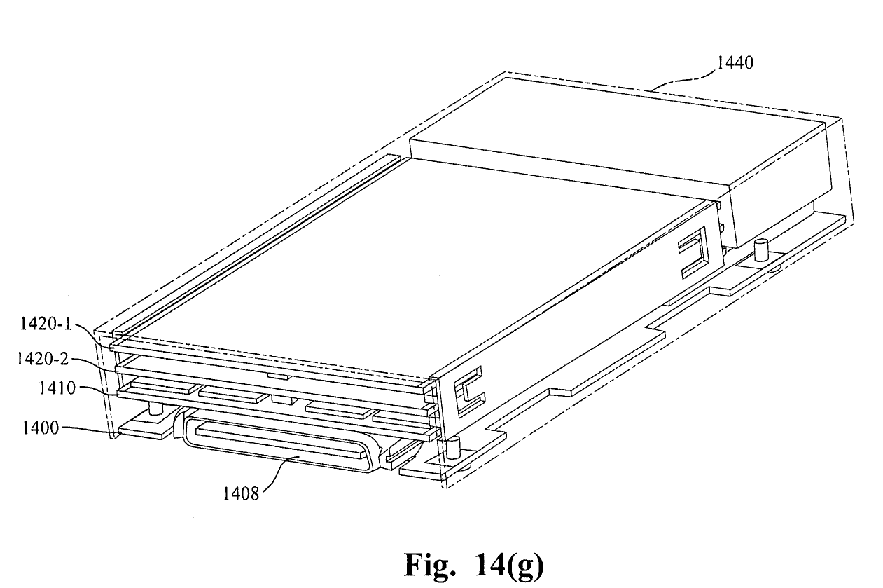

FIG. 14(a) shows an exemplary physical layout of a SCSI controller board SCB 1400, according to an embodiment of the present invention. The SCB 1400 has a plurality of components including, but not limited to, a SCSI controller chip such as 53C1030T with 456 pins 1404, an optional heat sink 1401 placed near the SCSI controller (e.g., on top of the SCSI controller) to extract the heat away from the SCSI controller, an ATA controller 1406 such as chip HP1371N, a backup storage disk 1403 such as Toshiba 1.8″ HDD disk, an ATA connector 1409 (underneath the HDD disk 1403), a DC-DC power converter 1402 with a battery monitor and a charger, a host SCSI connector 1408 (or SCSI backplane) through which a host system communicates with the SCSI controller, and SCSI connectors 1408-1, 1408-2, 1408-3 that connect the SCSI backplane to the SCSI controller. The SCB 1400 may also include an oscillator 1405, and two PCIX connectors PK5 with 100 pins 1407-1 and 1407-2. Exemplary sizes for various components and their operative power level are illustrated in FIG. 14(a).

FIG. 14(b) shows an exemplary physical layout of a DRAM controller board or DCB 1410, according to an embodiment of the present invention. The DCB 1410 physically embodies a general purpose processor chip 1418 such as 405 GPr with 456 pins, an SDRAM chip 1411, a flash memory chip 1412, a real-time clock chip 1413, an FPGA chip 1414 programmed as the PCIX Bus I/F and a DRAM controller, an RS232 interface 1415, two slots for DRAM connectors, i.e., a PAK5-140 slot 1416-1 and a PAK5-120 slot 1416-2, and two slots for PCIX connectors to the SCB 1400, i.e., PK5 1417-1 and 1417-2 corresponding to their counterparts 1407-1 and 1407-2 on the SCB 1400. Similarly, exemplary sizes and their operative power levels for different components of the DCB 1410 are also illustrated.

FIG. 14(c) shows an exemplary physical layout of memory chips on a memory board 1420, according to an embodiment of the present invention. In the illustration, there is a total of 36 memory stacks of 3 chips each arranged in four separate rows (1421, 1422, 1426, and 1427) with each row having 9 stacks (1421-1, . . . , 1421-9, 1422-1, . . . , 1422-9, 1426-1, . . . , 1426-9, and 1427-1, . . . , 1427-9). The four rows of stacks are aggregated into two groups of 18 stacks residing on each side of the physical board. Between the two groups, there are two PLL clocks 1424, a register buffer 1423, and two slots for DRAM connectors, i.e., a PAK5-140 1425-1 and a PAK5-120 1425-2 (which correspond to the counterpart connectors 1416-1 and 1416-2 on the DCB 1410). The exemplary physical sizes of each of the components and their operative power levels are indicated. Each memory stack may represent a memory capacity of certain number of bytes. As discussed earlier, there may be multiple memory boards included in the DMD 100.

FIG. 14(d) shows an exemplary physical arrangement of different boards of the DMD 100 in a compact box 1430, according to an embodiment of the present invention. There are a plurality of layers of boards and components arranged in a compact manner with considerations related to heat reduction, ease of component replacement, and efficiency in connections. According to one embodiment of the present invention, all components of he DMD 100 may be packaged in a low profile 3.5″ form factor that is deployable in any drive bay of any device. The top two layers include two memory boards 1420-1 and 1420-2, each of which has the memory chip arrangement as described with reference to FIG. 14(c). The two memory boards 1420-1 and 1420-2 are connected via the corresponding DRAM connectors 1425-1 and 1425-2 or the PAK5 140 and PAK5 120 connectors. Below the memory boards resides the DCB 1410, which connects to the above memory board (1420-2) via its DRAM connectors 1416-1 and 1416-2 to their counterparts on the memory board 1420, i.e., 1425-1 and 1425-2 (see FIG. 14(c)).

Below the DCB 1410 is the SCB 1400 on the bottom of the compact box 1430. The general-purpose processor chip 405 GPr (1418) is installed on the bottom side of the DCB 1410. The internal backup disk 1430 is on the left of the SCB 1400 with an ATA connector 1409 beneath it. The SCSI controller chip 1404 resides towards the right side of the SCB 1400 with a heat sink 1401 on its top. The host SCSI connector 1408 is located on the bottom right of the compact box 1430. The SCSI connectors 1480-1, 1408-2, and 1408-3 connect the host SCSI connector 1408 to the SCSI controller chip 1404. The SCB 1400 communicates with the DCB 1410 via the PCIX connectors located and aligned as counterparts on both boards (1407-1 v. 1417-1, and 1407-2 v. 1417-2). The two pairs of PCIX connectors are aligned in front of the SCSI controller chip 1404 and the heat sink 1401. The ATA controller 1404 is behind these connectors.

The two memory boards 1420-1 and 1420-2 as well as the DCB 1410 are narrower than the SCB 1400 and installed towards the right side of the compact box 1430. On the left of these smaller boards is the battery 1431, which is on the top left of the SCB 1400.

FIGS. 14(e) and (h) show different views of an implementation of the DMD 100 box, according to an embodiment of the present invention. In FIG. 14(e), the DMD box 1440 has various holes distributed to help to dissipate heat. In this view, the battery 1431 is on the top right, adjacent to the two memory boards 1420-1 and 1420-2, and the DCB 1410 and above the backup storage disk 1403 and its ATA connector 1409 (beneath the backup storage disk 1403) on the SCB 1400. The host SCSI connector 1408 is on the opposite side of the backup storage disk on the SCB 1400.

In one embodiment of the present invention, the DM1D 100 is packaged in a very compact manner in a box with a low profile 3.5″ form factor. As indicated earlier, the DMD 100 is a full-fledged computer. Its compact packaging with a low profile 3.5″ form factor makes it deployable in any drive bay of any device and may be used in a variety of applications, as discussed in more detail below.

FIG. 14(f) shows a view that is 90 degree rotated compared with FIG. 14(e). With this view, it can be seen that the SCSI controller chip 1404 is near the host SCSI connector 1408 and connected to the host SCSI connector 1408 via SCSI connectors 1408-1, 1408-2, and 1408-3 (not visible).

FIG. 14(g) shows a collapsed view of FIG. 14(f). When the boards are installed and the compact box 1430 is closed, what is seen from the backplane of the box is the host SCSI connector 1408, which is located at the same layer as the SCB 1400 and underneath the DCB 1410 and the two memory boards 1420-1 and 1420-2.

FIG. 14(h) shows the opposite side of the compact box 1430 when the boards are installed. The battery 1431 is on the edge of the box, which is adjacent to three smaller boards, the memory boards 1420-1 and 1420-2 and above the backup storage disk 1403 and its ATA connector 1409 on the SCB 1400.

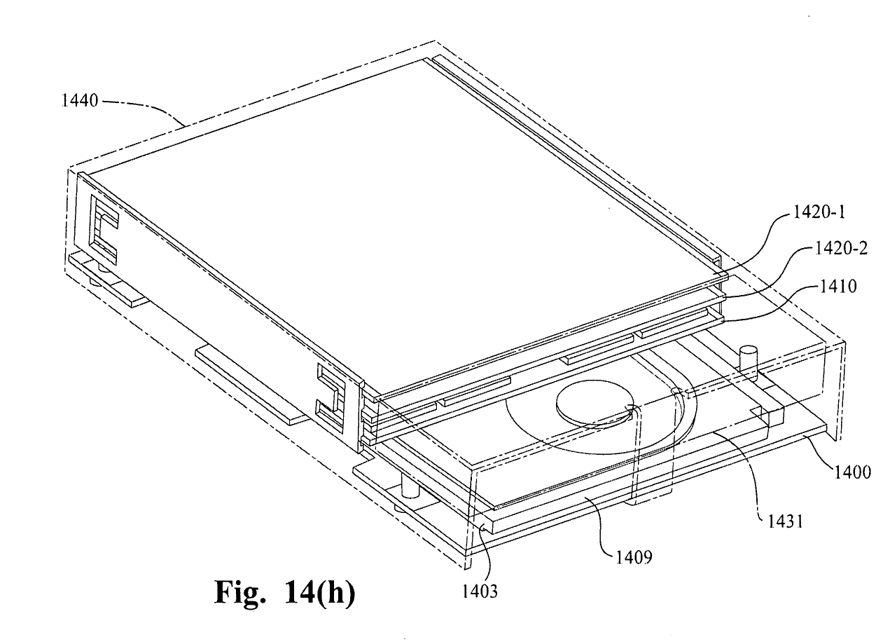

The DMD 100 as described above is a data processor in a low profile 3.5″ form factor and it is deployable in any drive bay of any device. FIG. 15(a) and FIG. 15(b) illustrate the DMD 100 deployed as a high speed disk storage emulator such as a standard low profile 3.5″ high-density disk (HDD). Since the DMD 100 is capable of conducting very high speed data movement, using the DMD 100 as a storage emulator provides an effective means for massive data storage at a high speed transfer. FIG. 15(a) shows an exemplary configuration when the DMD 100 is deployed as a high speed disk storage emulator for a plurality of host systems, i.e., a host system 1 1510, a host system 2 1520, . . . , and a host system K 1530. In this deployment, a host system may send a data request to the DM1D 100 via its SCSI/Fibre channel controller 140 (see FIG. 1). Upon receiving the data request, the DMD 100 processes the data request, accesses the requested data, and then sends a reply back to the requesting host system.

FIG. 15(b) shows a different exemplary configuration when the DMD 100 is deployed as a high speed disk storage emulator. In this configuration, a single host system 1540 may deploy a plurality of DMDs, i.e., a DMD 1 1560, a DMD 2 1570, . . . , and a DMD K 1580, for massive data storage. To coordinate among the multiple DMDs, a dispatcher 1550 may be deployed configured to direct data requests from the host system 1540 and forward responses from the DMDs to the host system 1540. Data stored in the multiple DMDs may be distributed according to various criteria determined, for example, according to application needs. For example, different logical parts of a database may be stored in different DMDs and a distribution map may be established and used by the dispatcher 1550 to determine how to direct requests and forward responses. Some of the DMDs may also be provided for fault tolerance purposes. Alternatively, the dispatcher may be configured to perform load balancing before dispatching a data request to a particular DMD.

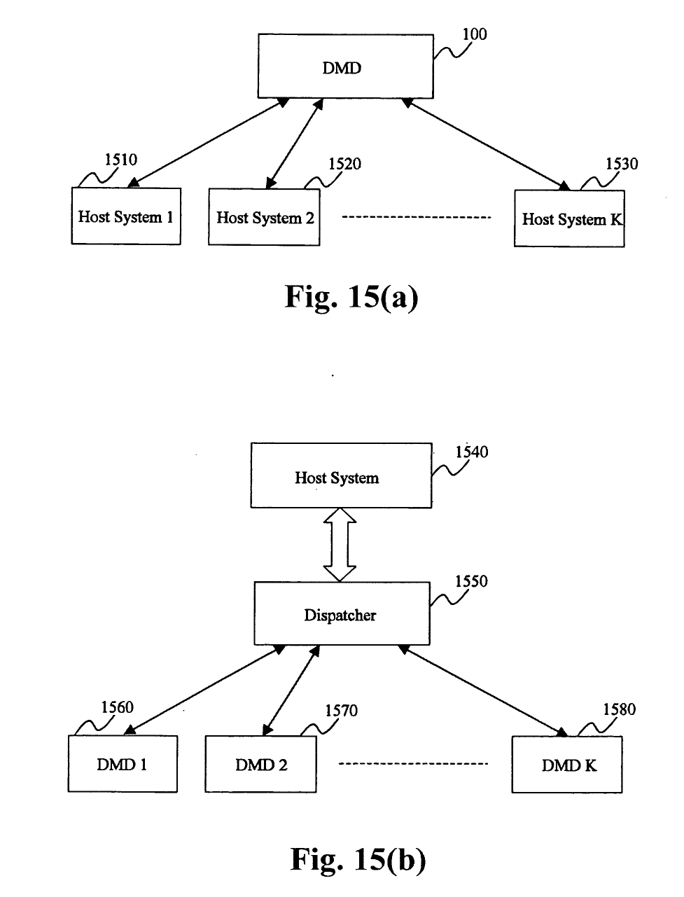

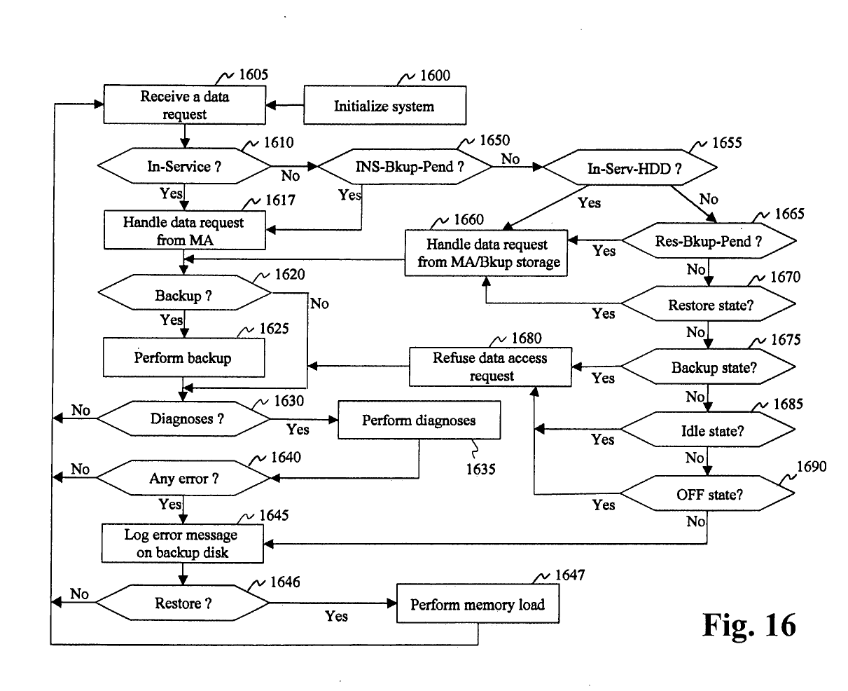

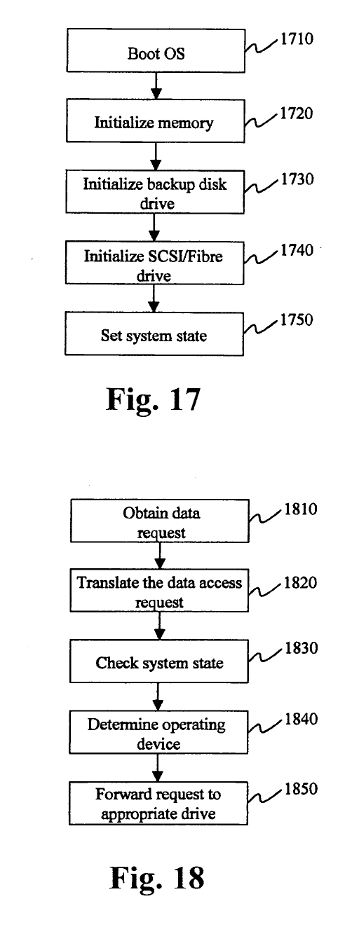

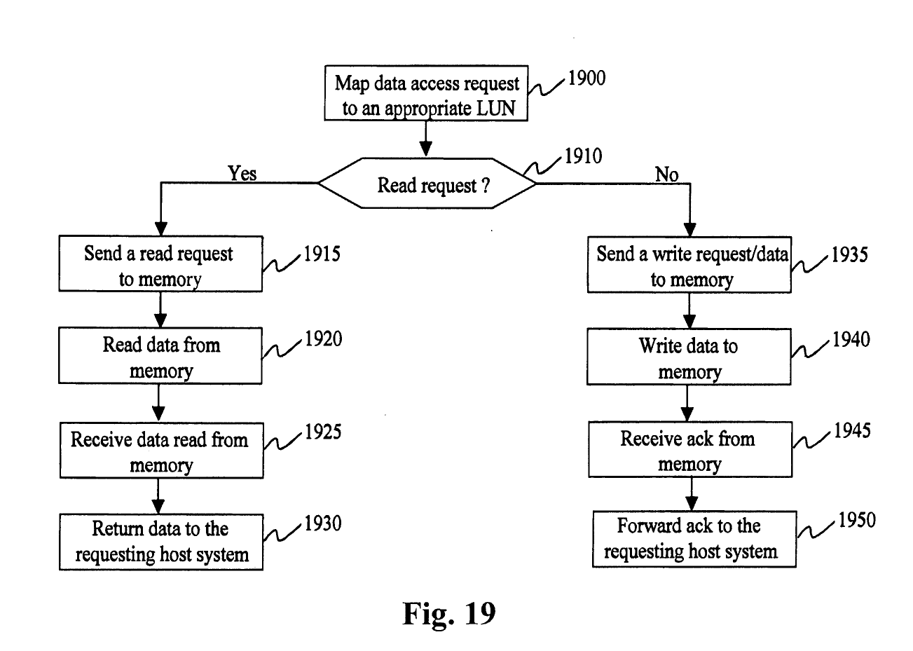

FIG. 16 is a flowchart of an exemplary process, in which the DMD 100 is used as a high speed disk emulator (e.g., emulating a solid state high speed disk) and handles a data request, according to an embodiment of the present invention. The system is initialized first at 1600. At the end of the initialization, an appropriate system state is set. Details related to the initialization process are discussed with reference to FIG. 17. After the initialization, the system receives, at 1605, a data request from a host system. Detailed processes relating to receiving a data request are discussed with reference to FIG. 18. When the data request is to access (i.e., read or write) some data stored in the DMD 100, the data transfer may be conducted directly through the FPGA 12 without going through the general processor 12 (as discussed with reference to FIG. 9). To service such a data request, the system determines the current system state. If the system state is in-service (state (4)) or in-service-backup-pending (system state (5)), determined at 1610 and 1650, respectively, the data request is handled accordingly, at 1615 from the memory 120. The process of handling a data request from the memory 120 is discussed with reference to FIG. 19.

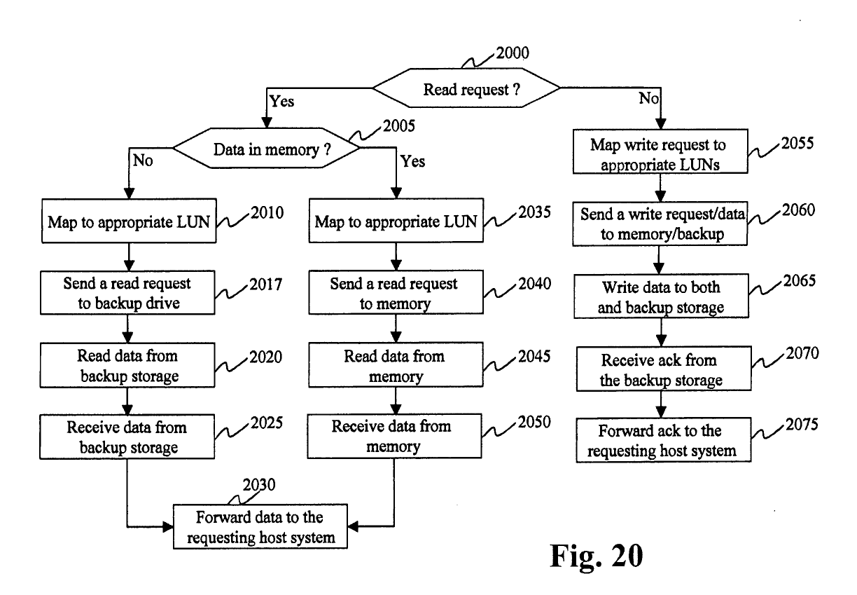

If the system state is in-service-backup (system state (3)), restore-backup-pending (system state (6)), or restore (system state (2)), determined at 1650, 1665, and 1670, respectively, the data request is handled accordingly, at 1660, from either the memory 120 or the backup storage 130, depending on the location of the data requested. Details related to data request processing from either the memory 120 or the backup storage 130 are discussed with reference to FIG. 20. If the system state is one of the backup states (system state (7)), the idle state (system state (8)), and the off state (system state (9)), determined t 1675, 1685, and 1690, respectively, the system refuses, at 1680, to serve the data request.

After the data request is handled (either served at 1615 or at 1660), the system checks, at 1620, whether a backup needs to be performed. The conditions under which a backup process needs to be initiated are discussed with reference to FIG. 8 (system state transitions). If a backup is needed, the DMD 100 invokes, at 1625, a backup process. During the backup (or restore) process, certain flags may be set at appropriate times to enable correct system state transition. For example, when a backup process is initiated, the system may set a backup flag so that the system will refuse all subsequent data requests prior to the completion of the backup process. Upon completion, the flag may be properly reset so that the system state transition may be initiated.

The system may also check, at 1630, whether certain diagnostic routines need to be performed. Exemplary criteria related to when to perform diagnostic routines are discussed above. For example, a regular interval may be set up so that such routines are performed regularly. The diagnostic routines may also be triggered by some software application(s) upon detection of certain events. Responsible personnel may also activate them externally. The diagnostic routines are performed at 1635. If there is any error detected during diagnosis, determined at 1640, the error messages are written or recorded, at 1645, in the backup storage 130.

The system may also check, at 1646, whether a restore process (memory load) needs to be initiated. Exemplary conditions under which a memory load process is initiated are discussed with reference to FIG. 8 (system state transitions). If restoration is needed, the process is performed at 1647. During this process, certain flags may be set to indicate that data is being moved from the backup storage 130 to the memory 120 so that a data request received under such a system state can be handled properly. Upon completion of the restore process, the flag is reset so that system state may be appropriately changed.

FIG. 17 is a flowchart of an exemplary process, in which the DMD 100 is initialized, according to an embodiment of the present invention. The operating system is first booted at 1710. Upon completion of booting the OS, the processor 210 initializes different drives, including the memory 120, at 1720, the backup storage drive, at 1730, and the SCSI/Fibre drive, at 1740. Based on the status of the initialization, the system then sets the appropriate system state at 1750.

FIG. 18 is a flowchart of an exemplary process, in which the processor 210 receives a data request and forwards the request to appropriate drive(s), according to an embodiment of the present invention. When the processor 210 receives, at 1810, a data request via its PCIX interface, it first translates, at 1820, the data request. Before it forwards the data request to an appropriate drive, the processor 210 determines, at 1830, the current system state. Based on the current system state and the nature of the data request, the processor 210 determines, at 1840, appropriate operating device from where the data request is to be handled and subsequently forwards, at 1850, the data request to such determined operating device.

FIG. 19 is a flowchart of an exemplary process, in which a data request is handled out of the memory 120, according to an embodiment of the present invention. Upon receiving a data request, the DMD 100 first maps, at 1900, the data request to an appropriate LUN structure based on, for example, the block size required. The nature of the data request is then analyzed at 1910. If the data request is a read request, a read request is sent, at 1915, to the memory 120. The data is then read at 1920. When the data read from the memory 120 is received at 1925, it is returned, at 1930, to the host system that made the data request. If the data request is a write request, a write request with the data to be written is sent, at 1935, to the memory 120. The data is written, at 1940, to the memory 120. When the data write is completed, an acknowledgement is received, 1945, from the memory 120 and is then forwarded, at 1950, to the host system that made the data request.

FIG. 20 is a flowchart of an exemplary process, in which a data request is handled from either the memory 120 or the backup storage 130, according to an embodiment of the present invention. As discussed earlier, when the system state is either in-service-backup (system state (3)), restore-backup-pending (system state (6)), or restore (system state (2)), a data request is handled either from the memory 120 or the backup storage 130, depending on the location of the data requested. To handle a data request in such conditions, the DMD 100 first determines, at 2000, whether the data request is a read or a write request.

If the data request is a read request, the location of the data to be read is determined at 2005. If the data to be read is located in the backup storage 130, an appropriate LUN structure is mapped, at 2010, based on the data request before a read request is sent, at 2015, to the backup storage 130. After the data is read, at 2020, from the backup storage 130, the data is received, at 2025, from the backup storage 130 and is then forwarded, at 2030, to the host system that made the read request.

If the data to be read is located in the memory 120, a read request is first mapped, at 2035, to an appropriate LUN structure before the data request is sent, at 2040, to the memory 120. After the data is read, at 2045, from the memory 120, it is received, at 2050, and subsequently forwarded, at 2030, to the requesting host system.

If the data request is a write request, determined at 2000, the DMD 100 may perform a write operation in both the memory 120 and the backup storage 130. In this case, the write request is first mapped, at 2055, to an appropriate LUN structure in both the memory 120 and the backup storage 130. The mapping may be performed according to the block size required. Based on the mapped LUN structure, a write instruction and the data to be written are sent, at 2060, to both the memory 120 and the backup storage 130 and at 2065, the data is then written to both storage spaces. When a write acknowledgement is received, at 2070, from the backup storage 130, the DMD 100 forwards the acknowledgement to the host system that made the write request.

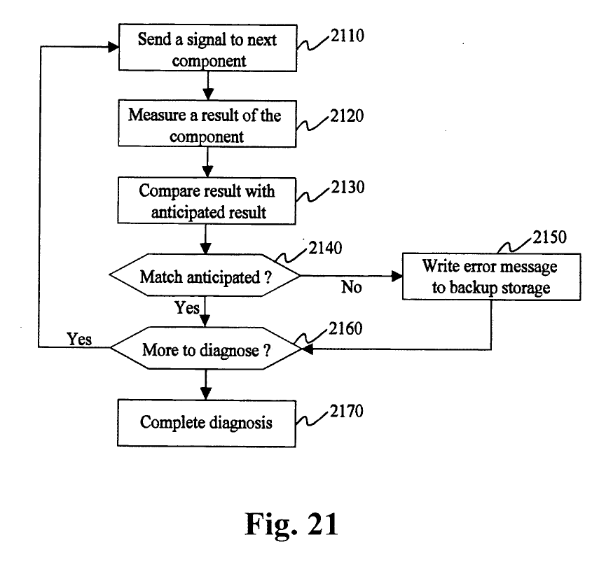

FIG. 21 is a flowchart of an exemplary process, in which a diagnosis is performed and error messages are recorded in the backup storage 130, according to an embodiment of the present invention. In this exemplary embodiment, the diagnosis may be performed one component at a time. To test a component of the DMD 100, a signal is first sent, at 2110, from the processor 210 to the component. The processor 210 then measures, at 2120, the result after the component receives the signal. The measured result is then compared, at 2130, with pre-stored anticipated result. If the measured result does not match the anticipated result, determined at 2140, it may indicate that the component is malfunctioning. In this case, error messages related to the test is written, at 2150, to the backup storage 130. The diagnosis process continues until, determined at 2160, all the components to be tested have been tested. The diagnosis process then ends at 2170.

The DMD 100 described herein may also be deployed for other purposes. For example, DMD may be deployed as a data off-load engine or device. In such an application, a server may off load its I/O intensive tasks to a DMD. Such a DMD may be required to share data between the DMD and the processor in the server. Data may need to be placed at a location that is accessible to both the DMD and the server. The DMD so deployed can provide high speed data manipulation according to the requirement of the designated tasks because data transfer/movement in DMD may be performed directly by the FPGA without going through the general purpose processor. Such an application is feasible because the DMD described herein has an open architecture and small in size. Therefore it can be easily embedded or connected to the server without needing any special device or software connections.

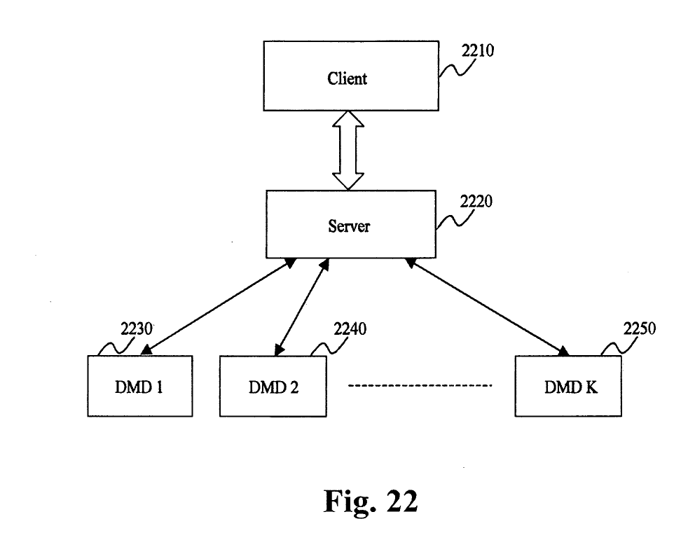

FIG. 22 illustrates an exemplary configuration in which one or more slave DMDs are deployed by a master server as data off-load engines or devices. In this embodiment, a plurality of DMDs (e.g., DMD 1 2230, DMD 2 2240, . . . , and DMD k 2250) are deployed by a server 2220 connected to one or more clients (e.g., a client 2210). When a client 2210 sends a service request to the server 2220, depending on the nature of the request, the server 2220 may direct some of the processing to one of the DMDs. Since the DMD described herein is a full fledged computing device, it is capable of performing data manipulations and processing at a very high speed. For instance, if a request is a query seeking an answer based on a search in a massive database, if the server is to perform the search itself, its computation power may be tied up so that the performance of the server may degrade. Alternatively, with the illustrated configuration, if the slave DMDs store different portions of the database and are configured to run database applications, the master server 2220 may direct one of the slave DMDs (which may have the appropriate portion of the database data stored therein) to perform the required massive search at a high speed. In this way, the master server effectively frees itself from I/O intensive tasks and does not have to devote its computation power to perform the search, effectively allowing the master server to focus on other services.

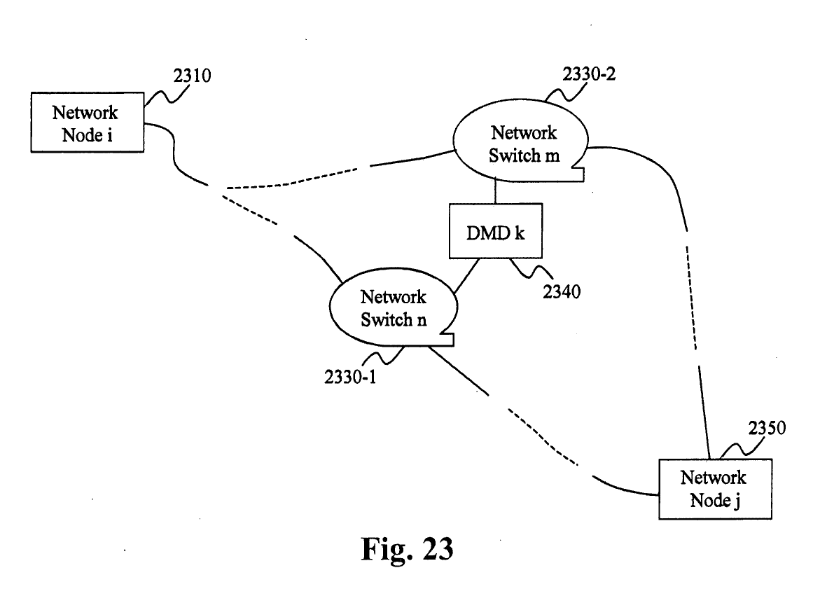

FIG. 23 illustrates another exemplary application of the DMD 100. In this illustration, a DMD is deployed as a network control mechanism. In this configuration, a network node i 2310 is connecting to another network node j 2350 via a dynamic network path determined by one or more network switches. To do so, a DMD 2340 may be deployed to provide high speed data manipulation capabilities to one or more network switches (e.g., network switch m 2330-1, . . . , and network switch n 2330-2). Such data manipulation tasks include various network control decision making such as traffic control and network management such as security and monitoring. In networking, switches are often required to dynamically direct the traffic based on information related to the traffic load and health of the network. Such dynamic network information is often analyzed and then flushed out at a rapid speed in order to effectively reflect the current state of the network traffic. In addition, information is often required to be shared among different switches and to be manipulated at a very high speed. The DMD 100 described herein is suitable to satisfy those requirements. A DMD deployed in such a setting may be equipped with necessary traffic control and/or management features in the form of, for instance, software or firmware. The FPGA direct path to access data stored therein permit the DMD to carry out data manipulation tasks at a very high speed.

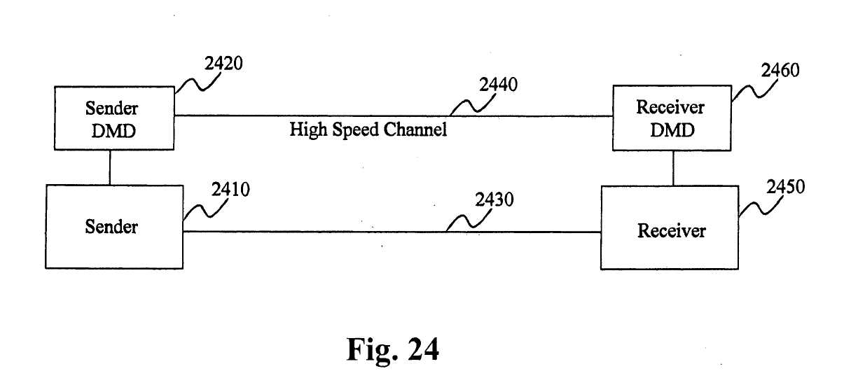

FIG. 24 illustrates another exemplary application of the DMD 100. In this embodiment, a DM1 may be deployed for high speed data manipulation for data transmission and receiving. This may be especially suitable when data transmission is related to data of high volume, over a high bandwidth channel such as multimedia or video information over a high speed network connections such as optical fiber network. In this application, a sender 2410 may be requested by a receiver 2450 to transmit certain data stored at the sender site. For example, in Video on Demand (VoD) applications, a user may request a service provider to transmit a movie via a cable network. Since such data is high in volume and the transmission time is often critical, the sender 2410 may deploy one or more DMDs (e.g., a DMD 2420) not only for data storage but also for high speed transmission. That is, the deployed DMD 2420 may be connected directly to the high speed connection 2440 (e.g. the cable network) and is responsible for various data operations to be performed prior to data transmission. For example, the requested data may need to be encrypted prior to be sent. Since DMD itself is a full fledged computing device instead of a passive storage device, a DMD deployed in this setting may be equipped with necessary encrypting applications. In addition, due to the FPGA path for direct accessing data without going through the general processor and other features described (e.g., alternative memory mode scheme), the DMD is capable of transferring data in and out of the memory at a very high rate, which is often necessary for multimedia and video applications.

Similarly, at the receiving site, another DMD 2460 may be deployed to perform high speed receiving and storage. In addition, the DMD 2460 may also be configured to perform data decryption, which may be performed prior to saving the received data in the DMD 2460 or when the stored data is retrieved by the receiver from the DMD's storage. For example, a user may request a movie via a Video on Demand service and the received movie may be store at the receiver site first in its encrypted form and later is retrieved and decrypted for viewing.

The above discussed examples are merely for illustration. The DMD 100 described herein has various unique features, including, but is not limited to, small in size, compact and open architecture, general data processing capability because of its employment of commercial CPU and OS, high speed because of its direct FPGA access of memory without going through processor and alternative memory mode scheme, inclusion of self-contained on-board backup storage. These features enable the DMD 100 to be deployable in a variety of different application scenarios as well as to be used, each as a nucleus in a large solid state disk system in a modular fashion. Such a highly modularized system is capable of handling multiple file structures within a single unit, effective implementation of data integrity, fault isolation, rapid backups and restoration, and fault tolerance.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

What is claimed is:

1. A data manipulation device, comprising:
a low profile from factor housing;
a memory, disposed in the housing, configured to provide data storage;
a memory controller, disposed in the housing, configured to control the memory;
a channel controller, disposed in the housing, connecting to the memory controller and configured to provide an interface to receive a data request and return information as a response to the data request; and
a backup storage, disposed in the housing, connecting to the channel controller and configured to provide a storage space for backing up the memory.

2. The data manipulation device according to claim 1, wherein the memory is solid state disk memory.

3. The data manipulation device according to claim 2, wherein the backup storage is used to store error logging messages.

4. The data manipulation device according to claim 2, wherein the backup storage is used as a memory space during a memory load from the backup storage to the memory.

5. The data manipulation device according to claim 1, wherein the memory has one or more LUN structures, wherein each of the LUN structures can be used to store data with different block sizes.

6. The data manipulation device according to claim 1, wherein the memory is divided into a plurality of memory portions and each of the memory portions can be independently set in one of a sleep mode, under which the memory portion is in a low consumption state and not accessible, and a wake-up mode, under which the memory portion is accessible.

7. The data manipulation device according to claim 2, wherein the channel controller is one of SCSI channel controller or a Fibre channel controller.

8. The data manipulation device according to claim 7, wherein the SCSI channel controller and the Fibre channel controller correspond to a common driver.

9. The data manipulation device according to claim 1, wherein the memory controller comprises:
a processor connecting to the channel controller and configured to control memory access;
a synchronous dynamic random access memory (SDRAM) connecting to the processor; and
a dynamic random access memory (DRAM) controller connecting to the memory and capable of directly accessing the memory.

10. The data manipulation device according to claim 9, wherein the processor is a general purpose processor.

11. The data manipulation device according to claim 10, wherein the general purpose processor is commercially available.

12. The data manipulation device according to claim 9, wherein an operating system is deployed on the processor and is capable of running on the processor.

13. The data manipulation device according to claim 12, wherein the operating system is a commercial operating system.

14. The data manipulation device according to claim 9, wherein the processor comprises:
a bus interface configured to interface with the channel controller;
a data access request handler in communication with the bus interface to process a data request;
a memory load handler configured to perform a memory load; and
a memory backup handler configured to move data from the memory to the backup storage.

15. The data manipulation device according to claim 14, wherein the processor further comprises:
a diagnostic mechanism configured to perform diagnosis routines;
an error logging mechanism configured to write error information produced by the diagnostic mechanism to the backup storage.

16. The data manipulation device according to claim 15, wherein the diagnostic mechanism is activated either through an external manual activation and/or by the operating system running on the processor.

17. The data manipulation device according to claim 15, wherein the diagnostic mechanism can be activated locally and/or remotely.

18. The data manipulation device according to claim 14, wherein the processor further comprises a memory status controller configured to control the mode of the different memory portions in the memory.

19. The data manipulation device according to claim 1, further comprising a battery system configured to provide power to the data manipulation device via a chargeable battery.

20. The data manipulation device according to claim 19, wherein the battery system comprises:
a rechargeable battery;
a monitor configured to monitor the power level of the rechargeable battery;
a battery charger configured to charge the battery; and
a DC-DC converter configured to convert the power from the rechargeable battery with a certain input voltage into one of a plurality of output voltages needed by the data manipulation device.

21. The data manipulation device according to claim 20, wherein the rechargeable battery can be automatically dissipated.

22. The data manipulation device according to claim 21, wherein the battery is periodically dissipated.

23. The data manipulation device according to claim 21, wherein the battery is dissipated when the battery reaches full power.

24. The data manipulation device according to claim 21, wherein the dissipation of the battery is controlled by the processor.

25. A data manipulation device according to claim 1, wherein the memory includes a solid state disk memory, disposed in the housing, configured to provide data storage.

26. The data manipulation device of claim 1, further comprising one or more host systems in communication with the data manipulation device, sending data requests and receiving responses from the data manipulation device.

27. The data manipulation device of claim 1, further comprising:
a master server configured to provide a service; and
one or more data manipulation devices acting as slave data manipulation devices in communication with the server.

28. A storage method, comprising:
sending, from a host system, a data request to a data manipulation device, the data manipulation device including a memory for data storage and a backup storage for backing up the memory, the memory including a plurality of memory portions, each of which can be set to be in one of a sleep mode, under which the memory portion is in a low power consumption state and not accessible, and a wake-up mode, under which the memory portion is accessible;
receiving, by the data manipulation device, the data request;
processing the data request by the data manipulation device according to a current system state of the data manipulation device;
sending, by the data manipulation device, a result as a response to the data request to the host system;
setting at least one memory portion to be accessed in wake-up mode and a remaineder of said portions in sleep mode; and
setting the at least one memory portion in sleep mode after the accessing.

29. The method according to claim 28, wherein the backup storage can be used as a temporary memory during a memory load from the backup storage to the memory.

30. The method according to claim 28, wherein the data manipulation device receives the data request via one of a SCSI and Fibre interface and the SCSI and the Fibre interface share a common driver.

31. The method according to claim 28, wherein the memory is a solid state disk memory.

32. The method according to claim 28, wherein the memory has a plurality of LUN structures, each of which is capable of storing data of at least two different block sizes.

33. The method according to claim 28, wherein the data manipulation device is capable of automatically dissipating its battery power when a condition is met.

34. The method according to claim 28, wherein the data manipulation device is capable of performing diagnostic routines.

35. The method according to claim 34, wherein error messages generated during diagnostic routines are written to the backup storage.

36. The method according to claim 28, wherein the data manipulation device employs a general purpose processor.

37. The method according to claim 36, wherein a commercial operating system is deployed and running on the general purpose processor.
